(19) United States
(12) Patent Application Publication
(10) Pub. No.: US 2025/0305956 A1
(43) Pub. Date: Oct. 2, 2025

(54) POLARIZATION BASED SENSING

(71) Applicant: Illumina, Inc., San Diego, CA (US)

(72) Inventors: Mohsen REZAEI, San Diego, CA (US); Craig HETHERINGTON, San Diego, CA (US); Paul SANGIORGIO, San Diego, CA (US); Craig CIESLA, San Diego, CA (US); Geraint EVANS, Great Abington (GB); Stanley HONG, San Diego, CA (US); Arvin EMADI, San Diego, CA (US)

(21) Appl. No.: 18/858,524

(22) PCT Filed: Apr. 20, 2023
(86) PCT No.: PCT/US2023/066004

§ 371 Date: Oct. 21, 2024

Related U.S. Application Data
(60) Provisional application No. 63/363,439, filed on Apr. 22, 2022.

(51) Int. Cl. G01N 21/64; G01N 21/21

(52) U.S. Cl. CPC G01N 21/6454; G01N 21/21; G01N 2201/08

(57) ABSTRACT

There is set forth herein, in one example, an apparatus. The apparatus can comprise, for example: a first reaction site and a second reaction site associated to a common pixel, wherein the pixel comprises a pixel sensor.

### CROSS-REFERENCE TO RELATED APPLICATIONS

This application claims priority to U.S. Patent Application No. 63/363,439 filed Apr. 22, 2022, entitled “Polarization Based Sensing” which is incorporated herein by reference in its entirety.

### BACKGROUND

The present application relates generally to sensing and specifically to light sensing.

Various protocols in biological or chemical research involve performing controlled reactions. The designated reactions can then be observed or detected and subsequent analysis can help identify or reveal properties of chemicals involved in the reaction. In some multiplex assays, an unknown analyte having an identifiable label (e.g., fluorescent label) can be exposed to thousands of known probes under controlled conditions. Each known probe can be deposited into a corresponding well of a microplate. Observing any chemical reactions that occur between the known probes and the unknown analyte within the wells can help identify or reveal properties of the analyte. Other examples of such protocols include known deoxyribonucleic acid (DNA) sequencing processes, such as sequencing-by-synthesis (SBS) or cyclic-array sequencing.

### SUMMARY

There is set forth herein, in one example, an apparatus. The apparatus can comprise, for example: a first reaction site and a second reaction site associated to a common pixel, wherein the pixel comprises a pixel sensor.

There is set forth herein, in one example, an apparatus. The apparatus can comprise, for example: a plurality of pixels; a first reaction site associated to a pixel of the plurality of pixels; a second reaction site associated to the pixel; wherein the first reaction site is configured to selectively transmit light of a first polarity; and wherein the second reaction site is configured to selectively transmit light of a second polarity.

There is set forth herein, in one example, an apparatus. The apparatus can comprise, for example: a plurality of pixels; a first reaction site associated to a pixel of the plurality of pixels; a second reaction site associated to the pixel; wherein the first reaction site and the second reaction site are configured so that under illumination by excitation light of a first polarity, the first reaction site and the second reaction site exhibit a photonic power transmission ratio in favor of the first reaction site.

There is set forth herein, in one example, a method. The method can comprise, for example: detecting, using a pixel sensor of a plurality of pixels sensors, a read signal, the read signal being dependent on a first cluster signal emitted from a first reaction site associated to the pixel sensor under illumination by excitation light of a first polarity; detecting, using a pixel sensor of a plurality of pixels sensors, a second read signal, the second read signal being dependent on a second cluster signal emitted from a second reaction site associated to the pixel sensor under illumination by excitation light of a second polarity; determining an identity of a first analyte of interest in the first reaction site in dependence on the read signal detected using the pixel sensor; and determining an identity of a second analyte of interest in the second reaction site in dependence on the second read signal detected using the pixel sensor.

There is set forth herein, in one example, a method. The method can comprise, for example: illuminating a first reaction site and a second reaction site by excitation light of a first polarity, the first reaction site and second reaction site associated to a pixel of a plurality of pixels; detecting, using a pixel sensor of the pixel, a first read signal; illuminating the first reaction site and the second reaction site by excitation light of a second polarity; detecting, using the pixel sensor of the pixel, a second read signal; determining an identity of a first analyte of interest in the first reaction site in dependence on the first read signal detected using the pixel sensor; and determining an identity of a second analyte of interest in the second reaction site in dependence on the second read signal detected using the pixel sensor.

Additional features are realized through the techniques described herein. Other examples and aspects are described in detail herein and are considered a part of the claimed aspects. These and other objects, features and advantages of this disclosure will become apparent from the following detailed description of the various aspects of the disclosure taken in conjunction with the accompanying drawings.

It should be appreciated that all combinations of the foregoing aspects and additional concepts discussed in greater detail below (provided such concepts are not mutually inconsistent) are contemplated as being part of the inventive subject matter and to achieve the benefits advantages disclosed herein.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a side cross-sectional view of an apparatus for use in analysis;

FIG. 2 is a top cross-sectional view of the apparatus shown in FIG. 1;

FIG. 3 is a schematic view of the apparatus shown in FIG. 1;

FIG. 4 is a spectral profile diagram illustrating coordination between excitation light, emission light, and a detector detection band;

FIG. 5 depicts top and front cross-sectional views of a reaction structure according to one example;

FIGS. 6A and 6B are performance diagrams illustrating photon transmission performance of first and second reaction sites associated to a pixel according to one example;

FIGS. 7A and 7B are performance diagrams illustrating photon transmission performance of first and second reaction sites associated to a pixel according to one example;

FIGS. 8A and 8B are performance diagrams illustrating photon transmission performance of first and second reaction sites associated to a pixel according to one example;

FIGS. 9A and 9B are performance diagrams illustrating photon transmission performance of first and second reaction sites associated to a pixel according to one example;

FIGS. 10A and 10B are performance diagrams illustrating photon transmission performance of first and second reaction sites associated to a pixel according to one example;

FIGS. 11A and 11B are performance diagrams illustrating photon transmission performance of first and second reaction sites associated to a pixel according to one example;

FIG. 12 depicts top and front cross-sectional views of a reaction structure according to one example;

FIG. 13A is a top cross-sectional view of a reaction site according to one example;

FIG. 13B is a top cross-sectional view of a reaction site according to one example;

FIG. 14 is a top cross-sectional view of a reaction structure according to one example;

FIG. 15 is a top cross-sectional view of a reaction structure according to one example;

FIG. 16 is a top cross-sectional view of a reaction structure according to one example;

FIG. 17 is a top cross-sectional view of a reaction structure according to one example;

FIG. 18 is a top cross-sectional view of a reaction structure according to one example;

FIG. 19 is a top cross-sectional view of a reaction structure according to one example;

FIG. 20 is a top cross-sectional view of a reaction structure according to one example;

FIG. 21 is a flowchart depicting a process that can be used in support of a DNA sequencing process for DNA sequence reconstruction.

### DETAILED DESCRIPTION

The accompanying figures, in which like reference numerals refer to identical or functionally similar elements throughout the separate views and which are incorporated in and form a part of the specification, further illustrate the present implementation(s) and, together with the detailed description of the implementation(s), serve to explain the principles of the present implementation(s). As understood by one of skill in the art, the accompanying figures are provided for ease of understanding and illustrate aspects of certain examples of the present implementation(s). The implementation(s) is/are not limited to the examples depicted in the figures.

The terms “connect,” “connected,” “contact,” “coupled,” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially,” “approximately,” “about,” “relatively,” or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. If used herein, the terms “substantially,” “approximately,” “about,” “relatively,” or other such similar terms may also refer to no fluctuations, that is, ±0%. It is contemplated that numerical values, as well as other values that are recited herein can be modified by the term “about”, whether expressly stated or inherently derived by the discussion of the present disclosure. Further, any description of a range herein can encompass all subranges.

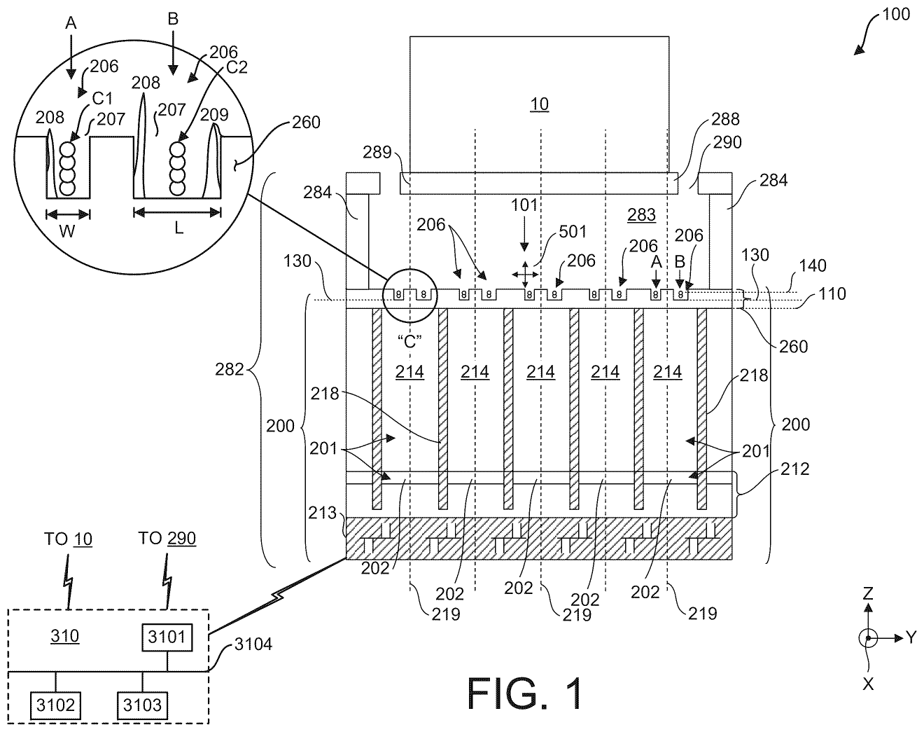

In FIG. 1 there is shown an apparatus 100 for use in analysis, such as biological or chemical analysis. Apparatus 100 can include light energy exciter 10 and flow cell 282. Flow cell 282 can include detector 200 and an area above detector 200. Detector 200 can include a plurality of pixels 201 and detector surface 209 for supporting clusters C1, C2 such as biological or chemical samples subject to test. Sidewalls 284 and flow cover 288, as well as detector 200 having detector surface 209, can define and delimit flow channel 283. Elevation 130 can define a cluster supporting surface of reaction structure 260 according to one example. Where reaction structure 260 includes nanowells, elevation 130 can define an elevation of a plane that extends coextensively with respective cluster supporting bottom surfaces of such nanowells. Respective pixels 201 can include a light guide 214 and a pixel sensor 202. Clusters C1, C2, in one example, can comprise, e.g., biological or chemical samples subject to test. In one example, a cluster herein, e.g., C1, and/or C2, can include one or more strand, such as one or more DNA strand. Strands herein, according to one example can include monoclonal DNA strands.

In a further aspect, detector surface 209 can be configured to define reaction sites 206 which, in one example, can be provided by nanowells 208. According to one example, each reaction site 206 can be associated to a certain pixel 201 and certain pixel sensor 202 of the certain pixel 201. Each of cluster C1 and cluster C2 can be supported on a respective reaction site 206 defined by a nanowell 208, according to one example. Detector surface 209 can be defined by surfaces defining nanowells, as well as surfaces intermediate of nanowells as is indicated by FIG. 1.

Detector 200 can include, according to one example, dielectric stack 213, semiconductor layer 212, and light guides 214 disposed in a light path between detector surface 209 and pixel sensors 202, and isolation structures 218 defining and delimiting pixel areas above respective ones of pixel sensors 202. Dielectric stack 213 can, in one example, include metallization layers defining various circuitry, e.g., circuitry for readout of signals from sensing pixels, digitization, storage, and signal processing. Metallization layers defining such circuitry can additionally or alternatively be incorporated into isolation structures 218.

Pixel sensors 202, in one example, can be provided by sensing photodiodes. Sensing photodiodes, in one example, can be defined by doped areas of semiconductor layer 212. Examples herein recognize that “area” as referred to herein can refer to a volumetric space (in other words, not limited to a 2-dimensional space).

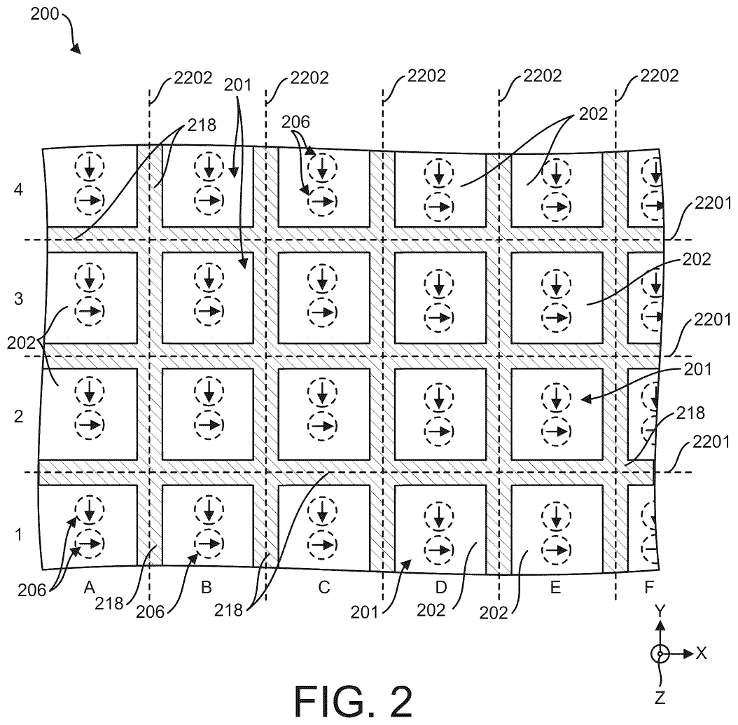

According to one example, detector 200 can be provided by a solid-state integrated circuit detector, such as complementary metal oxide semiconductor (CMOS) integrated circuit detector or a charge coupled device (CCD) integrated circuit detector. Pixel sensors 202, in one example, can be provided in a two-dimensional pixel array having rows and columns of pixels arranged in a grid pattern that is shown in the cross-sectional top view of FIG. 2 taken along the elevation of pixel sensors 202. In one example, such pixel array can include at least 1M pixels, or can include fewer pixels.

In one aspect, pixels 201 herein can include respective pixel sensors 202 and light guides 214. Light guides 214 can be disposed in an area above respective pixel sensors 202 and can be bounded by isolation structures 218 and reaction structure 260.

According to one example, apparatus 100 can be used for performance of biological or chemical testing with use of analytes provided by fluorophores. For example, a fluid having one or more fluorophores can be caused to flow into and out of flow cell 282 through an inlet port using inlet port 289 and outlet port 290. Analytes provided by fluorophores can attract to various clusters C1, C2 and thus, by their detection, analytes provided by fluorophores can act as markers for the clusters C1, C2, e.g., biological or chemical analytes to which they attract.

To detect the presence of an analyte provided by a fluorophore within flow cell 282, light energy exciter 10 can be energized so that excitation light 101 in an excitation wavelength range is emitted by light energy exciter 10. On receipt of excitation light 101, fluorophores attached to clusters C1, C2 can radiate emission light 501, which is the signal of interest for detection by pixel sensors 202. Emission light 501 owing to fluorescence of a fluorophore attached to a cluster C1, C2 can have a wavelength range red shifted relative to a wavelength range of excitation light 101.

Light energy exciter 10 can include at least one light source and at least one optical component to illuminate clusters C1, C2. Examples of light sources can include, e.g., lasers, arc lamps, LEDs, or laser diodes. The optical components can include, for example, reflectors, dichroics, beam splitters, collimators, lenses, filters, wedges, prisms, mirrors, detectors, and the like. In examples that use an illumination system, the light energy exciter 10 can be configured to direct excitation light 101 to reaction sites 206. As one example, fluorophores can be excited by light in the green wavelength range, e.g., can be excited using excitation light 101 having a center (peak) wavelength of about 523 nm.

Examples herein recognize that a signal to noise ratio of apparatus 100 can be expressed as set forth in the equation of (1) hereinbelow.

Examples herein recognize that a signal to noise ratio of apparatus 100 can be expressed as set forth in the equation of (1) hereinbelow.

$$SNR = \frac{Signal}{\sqrt{Signal + Excitation + AF + Background + Dark Current + Read Noise \hat{} 2}} \qquad ( Eq . 1 )$$

where “Signal” is the emission light 501, i.e. the signal of interest light attributable to the fluorescence of a fluorophore attached to a cluster, “Excitation” is unwanted excitation light reaching the pixel sensors 202, “AF” is the autofluorescence noise radiation of one or more autofluorescence sources within detector 200, “Background” is unwanted light energy transmitted into detector 200 from a source external to detector 200, “Dark Current” is current flow noise associated to random electron-hole pair generation in the absence of light, and “Read Noise” is noise associated to analog-to-digital electronics.

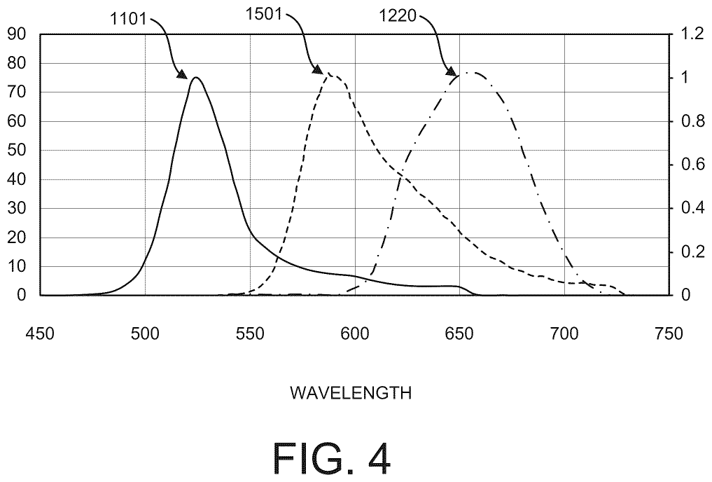

FIG. 4 is an example of a spectral profile coordination diagram illustrating targeted coordination between a wavelength range of excitation light, a wavelength range of signal light, and a detection wavelength range. In the spectral profile coordination diagram of FIG. 4, spectral profile 1101 shown as a green light spectral profile is the spectral profile of excitation light 101 as emitted by light energy exciter 10. Spectral profile 1501 is the spectral profile of the emission light 501 caused by the fluorescence of a fluorophore on being excited by excitation light 101. Spectral profile 1220 is the transmission profile (detection band) of pixel sensors 202, according to one example. It will be understood that the spectral profile coordination diagram of FIG. 4 is intended to represent general features common to some examples, but that variations of the indicated spectral profiles are common. In one aspect, excitation light 101 can commonly include, in addition to a green light spectral profile, a blue light spectral profile (not shown) wherein apparatus 100 is switchable between modes in which (a) the green light spectral profile is active with the blue light spectral profile being inactive, and (b) the blue light spectral profile is active with the green light spectral profile being inactive. In other examples, there can be different combinations of excitation light 101 and emission light 501. In one example, the spectral profile 1101 of excitation light 101 can feature a center wavelength in the blue light wavelength range and the spectral profile of emission light 501 can feature a center wavelength in the green wavelength range.

Detector 200 can be configured to detect light in the wavelength range indicated by spectral profile 1220. Spectral profile 1220 specifies the detection wavelength range with amplitude of spectral profile 1220 indicating a level of sensitivity. Thus, referring to the spectral profile coordination diagram of FIG. 4, detector 200 is able to detect emission light 501 in the range of wavelengths wherein the spectral profile 1501 of the emission light 501 and the detection band spectral profile 1220 of pixel sensors 202 intersect.

As used herein and further referring to the exemplary view of FIG. 1, a “flow cell” 282 can include a device having a lid 288 extending over a reaction structure 260 to form a flow channel 283 therebetween that is in communication with a plurality of reaction sites 206 of the reaction structure. In some examples, a detection device, such as an imaging device and/or optics, are separate from the flow cell 282. In other examples, as shown in FIG. 1, a flow cell 282 can include a detection device, e.g., detector 200 that detects designated reactions that occur at or proximate to the reaction sites. A flow cell 282 may include a solid-state light detection or “imaging” device, such as a Charge-Coupled Device (CCD) or Complementary Metal-Oxide Semiconductor (CMOS) (light) detection device. The CMOS detection device or sensor, for example, may include a plurality of detection pixels 201 (pixels) that detect incident emission signals. In some examples, each pixel 201 corresponds to a reaction site. In other examples, there may be more or fewer pixels 201 than the number of reaction sites. Likewise, a pixel 201, in some examples, corresponds to a single sensing element to create an output signal. In other examples, a pixel 201 corresponds to multiple sensing elements to create an output signal. A flow cell 282 can also or alternatively include two (or more) opposing sensors, without a lid. As one specific example, a flow cell 282 can fluidically, electrically, or both fluidically and electrically couple to a cartridge, which can fluidically, electrically, or both fluidically and electrically couple to a bioassay system. A cartridge and/or bioassay system may deliver a reaction solution to reaction sites 206 of a flow cell 282, according to a predetermined protocol (e.g., sequencing-by-synthesis), and perform a plurality of imaging events. For example, a cartridge and/or bioassay system may direct one or more reaction solutions through the flow channel of the flow cell, and thereby along the reaction sites. At least one of the reaction solutions may include four types of nucleotides having the same or different fluorescent labels. In some examples, the nucleotides bind to the reaction sites 206 of the flow cell 282, such as to corresponding oligonucleotides at the reaction sites. The cartridge, bioassay system, or the flow cell 282 itself, in some examples, then illuminates the reaction sites 206 using an excitation light source (e.g., solid-state light sources, such as light-emitting diodes (LEDs)). In some examples, the excitation light has a predetermined wavelength or wavelengths, including a range of wavelengths. The fluorescent labels excited by the incident excitation light may provide emission signals (e.g., light of a wavelength or wavelengths that differ from the excitation light and, potentially, each other) that may be detected by the light sensors of the flow cell 282.

Flow cells 282 described herein can perform various biological or chemical processes and/or analysis. More specifically, the flow cells 282 described herein may be used in various processes and systems where it is desired to detect an event, property, quality, or characteristic that is indicative of a designated reaction. For example, flow cells 282 described herein may include or be integrated with light detection devices, sensors, including but not limited to, biosensors and their components, as well as bioassay systems that operate with sensors, including biosensors.

The flow cells 282 facilitate a plurality of designated reactions that may be detected individually or collectively. The flow cells 282 perform numerous cycles in which the plurality of designated reactions occurs in parallel. For example, the flow cells 282 may be used to sequence a dense array of DNA features through iterative cycles of enzymatic manipulation and light or image detection/acquisition. As such, the flow cells 282 may be in fluidic communication with one or more microfluidic channels that deliver reagents or other reaction components in a reaction solution to a reaction site 206 of the flow cells. The reaction sites 206 may be provided or spaced apart in a predetermined manner, such as in a uniform or repeating pattern. Alternatively, the reaction sites 206 may be randomly distributed. Each of the reaction sites 206 may be associated with one or more light guides 214 and one or more light sensors that detect light from the associated reaction site 206. In one example, light guides 214 include one or more filters for filtering certain wavelengths of light. The light guides 214 may be, for example, an absorption filter (e.g., an organic absorption filter) such that the filter material absorbs a certain wavelength (or range of wavelengths) and allows at least one predetermined wavelength (or range of wavelengths) to pass therethrough. In some flow cells, the reaction sites 206 may be located in reaction recesses or chambers, which may at least partially compartmentalize the designated reactions therein. Furthermore, the designated reactions may involve or be more easily detected at temperatures other than at ambient temperatures, for example, at elevated temperatures.

As used herein, a “designated reaction” includes a change in at least one of a chemical, electrical, physical, or optical property (or quality) of a chemical or biological substance of interest, such as an analyte-of-interest. In particular flow cells, a designated reaction is a positive binding event, such as incorporation of a fluorescently-labeled biomolecule with an analyte-of-interest, for example. More generally, a designated reaction may be a chemical transformation, chemical change, or chemical interaction. A designated reaction may also be a change in electrical properties. In particular flow cells such as flow cell 282, a designated reaction includes the incorporation of a fluorescently-labeled molecule with an analyte. The analyte may be an oligonucleotide and the fluorescently-labeled molecule may be a nucleotide. A designated reaction may be detected when an excitation light is directed toward the oligonucleotide having the labeled nucleotide, and the fluorophore emits a detectable fluorescent signal. In another example of flow cells, the detected fluorescence is a result of chemiluminescence or bioluminescence. A designated reaction may also increase fluorescence (or Förster) resonance energy transfer (FRET), for example, by bringing a donor fluorophore in proximity to an acceptor fluorophore, decrease FRET by separating donor and acceptor fluorophores, increase fluorescence by separating a quencher from a fluorophore, or decrease fluorescence by co-locating a quencher and fluorophore. A biological or chemical analysis may include detecting a designated reaction.

As used herein, “electrically coupled” and “optically coupled” refers to a transfer of electrical energy and light waves, respectively, between any combination of a power source, an electrode, a conductive portion of a substrate, a droplet, a conductive trace, wire, waveguide, nanostructures, other circuit segment, and the like. The terms electrically coupled and optically coupled may be utilized in connection with direct or indirect connections and may pass through various intermediaries, such as a fluid intermediary, an air gap, and the like. Likewise, “fluidically coupled” refers to a transfer of fluid between any combination of sources. The term fluidically coupled may be utilized in connection with direct or indirect connections and may pass through various intermediaries, such as channels, wells, pools, pumps, and the like.

As used herein, a “reaction solution,” “reaction component,” or “reactant” includes any substance that may be used to obtain at least one designated reaction. Potential reaction components include reagents, enzymes, other biomolecules, and buffer solutions, for example. The reaction components may be delivered to a reaction site 206 in the flow cells 282 disclosed herein in a solution and/or immobilized at a reaction site. The reaction components may interact directly or indirectly with another substance, such as an analyte-of-interest immobilized at a reaction site 206 of the flow cell 282.

As used herein, the term “reaction site” can refer to a localized region where at least one designated reaction may occur. A reaction site 206 may include support surfaces of a reaction structure provided by reaction structure 260 defining a substrate where a substance may be immobilized thereon. For example, a reaction site 206 may include a surface of a reaction structure (which may be positioned in a channel of a flow cell) that has a reaction component thereon, such as a cluster C1, C2, which in one example can include colony of nucleic acids thereon. In some flow cells such as flow cell 282, nucleic acids in the colony in the described example can have the same sequence, being for example, clonal copies of a single-stranded or double-stranded template. However, in some flow cells 282, a reaction site 206 may contain only a single nucleic acid molecule, for example, in a single-stranded or double-stranded form.

As used herein, the term “transparent” refers to allowing all or substantially all visible and non-visible electromagnetic radiation or light of interest to pass through unobstructed; the term “opaque” refers to reflecting, deflecting, absorbing, or otherwise obstructing all or substantially all visible and non-visible electromagnetic radiation or light of interest from passing through; and the term “non-transparent” refers to allowing some, but not all, visible and non-visible electromagnetic radiation or light of interest to pass through unobstructed.

As used herein, the term “waveguide” refers to a structure that guides waves, such as electromagnetic waves, with minimal loss of energy by restricting the transmission of energy to a particular direction or range of directions.

As used herein, the term “associated” refers to something being directly or indirectly connected to something else; for example, a first element associated with a second element may refer to a first element being located over or on a second element.

The proposed methods and structures provide many benefits including higher throughput and lower cost of sequencing data.

In the example of FIG. 1, respective ones of pixels 201 can have associated thereto first and second reaction sites 206. In one example, each pixel 201 of detector 200 can have associated thereto a first reaction site 206 at A and a second reaction site at B. The first and second reaction sites 206 associated to the respective pixels can have first and second different respective configurations. In one aspect, the first reaction site 206 at A associated to a pixel 201 at “C” can be configured to selectively transmit light rays of excitation light 101 of a first polarization, and the second reaction site 206 at B associated to the pixel 201 at “C” can be configured to selectively transmit light rays of excitation light 101 of a second polarization. In another aspect, the first reaction site 206 at A associated to the pixel at “C” can be configured to selectively block light rays of excitation light 101 of the second polarization and the described second reaction site 206 at B associated to the pixel at “C” can be configured to selectively block light rays of excitation light 101 in the first polarization. Respective pixels 201 and pixel sensors 202 can include respective vertically extending center axes 219. In one example, respective vertically extending center axes 219 can extend through an area of a top surface 209 of reaction structure 260 that is between first and second reaction sites 206 associated to a given pixel 201 and pixel sensor 202.

Examples herein recognize that a reaction site that is configured to “selectively transmit” light rays may not transmit all photons incident on the reaction site of a specified polarity and that a reaction site configured to “selectively block” light rays may not block all incidence photons of a specified polarity. Rather, examples herein recognize that “selectively transmit” and “selectively block” are used as relative and functional terms. In one aspect, a first reaction site 206 that selectively transmits photons of a first polarity can facilitate the detection of transmitted photons by pixel sensor 202 associated to the first reaction site 206 as photons intended to be transmitted.

In one aspect, a first reaction site 206 at A of FIG. 1 that selectively transmits photons of a first polarity can facilitate the detection of on state emission light rays of emission light 501 by pixel 201 at “C” having a pixel sensor 202 resulting from excitation by light rays of excitation light 101 of the first polarity. In one aspect, a second reaction site 206 at B of FIG. 1 that selectively blocks photons of the first polarity can facilitate the non-detection of on state emission light rays of emission light 501 by pixel 201 at “C” having the pixel sensor 202 resulting from excitation by light rays of excitation light 101 of the first polarity. In one aspect, a second reaction site 206 at B of FIG. 1 that selectively transmits photons of a second polarity can facilitate the detection of on state emission light rays of emission light 501 by pixel 201 at “C” having a pixel sensor 202 resulting from excitation by light rays of excitation light 101 of the second polarity. In one aspect, a first reaction site 206 at A of FIG. 1 that selectively blocks photons of the second polarity can facilitate the non-detection of on state emission light rays of emission light 501 by pixel 201 at “C” having the pixel sensor 202 resulting from excitation by light rays of excitation light 101 of the second polarity. Non-detection and detection of emission light rays of emission light 501 as on state emissions can be achieved by establishing appropriate signal thresholding levels, so that emissions from a reaction site 206 operating to block light of a specified polarity are not erroneously detected as on state signals, and so that emissions from a reaction site 206 operating to transmit light of a specified polarity are properly detected as on state signals.

In another aspect, first and second reaction sites 206 associated to a certain pixel 201 can be configured so that under illumination by excitation light rays of excitation light 101 of a first polarity and then a second polarity, the reaction sites can feature differentiated photonic power transmission ratios. Under illumination by excitation light 101 of a first polarity, a pixel position having first and second reaction sites can exhibit a photonic power transmission ratio in favor of the first reaction site. Under illumination by excitation light 101 of a second polarity, a pixel position having first and second reaction sites can exhibit a photonic power transmission ratio in favor of the second reaction site. There is set forth herein, in one aspect, a plurality of pixels; a first reaction site associated to a pixel of the plurality of pixels; a second reaction site associated to the pixel; wherein the first reaction site and the second reaction site are configured so that under illumination by excitation light of a first polarity, the first reaction site and the second reaction site exhibit a photonic power transmission ratio in favor of the first reaction site, and further so that so that under illumination by excitation light of a second polarity, the second reaction site and the first reaction site exhibit a photonic power transmission ratio in favor of the second reaction site. In one example, the photonic power transmission ratio in favor of the first reaction site under illumination by excitation light of the first polarity can be at least about 2:1, and the photonic power transmission ratio in favor of the second reaction site under illumination by excitation light of the second polarity can be at least about 2:1. In one example, the photonic power transmission ratio in favor of the first reaction site under illumination by excitation light of the first polarity can be at least about 5:1, and the photonic power transmission ratio in favor of the second reaction site under illumination by excitation light of the second polarity can be at least about 5:1. In one example, the photonic power transmission ratio in favor of the first reaction site under illumination by excitation light of the first polarity can be at least about 10:1, and the photonic power transmission ratio in favor of the second reaction site under illumination by excitation light of the second polarity can be at least about 10:1. By selectively transmitting and selectively blocking excitation, positive photonic power transmission ratios as set forth herein are defined. When a first reaction site is selectively transmitting and a second reaction site is selectively blocking excitation light of a first polarity, a positive photonic power transmission ratio can be defined in favor of the first reaction site. When a second reaction site is selectively transmitting and a first reaction site is selectively blocking excitation light of a second polarity, a positive photonic power transmission ratio can be defined in favor of the second reaction site.

Referring to the exploded view section of FIG. 1, reaction site 206 at A associated to the pixel 201 at “C” can be a first reaction site having a first configuration and reaction site 206 at B can be a second reaction site associated to the pixel 201 at “C” having a second configuration. The first configuration can be differentiated from the second configuration. In one aspect, the first configuration and the second configuration can have different shapes. In one aspect, the first configuration and the second configuration can have different orientations. In one aspect, the first configuration and the second configuration can have common shapes but different orientations. In one aspect, the first reaction site 206 and the second reaction site 206 can have respective apertures 207. The respective apertures 207 of the respective reaction sites 206 can have first and second configurations. In one aspect, the first configuration can include a first aperture configuration. In one aspect, a second configuration can include a second aperture configuration. In one aspect the first aperture configuration can include a first orientation. In one aspect, the second aperture configuration can include a second orientation.

Referring to apparatus 100 as shown in FIG. 1, a top of pixels defining a pixel array can be defined at elevation 110. Elevation 110 can also define a bottom elevation of reaction structure 260. Elevation 130 can define a cluster supporting surface of reaction structure 260 according to one example. Where reaction structure 260 includes nanowells, elevation 130 can define an elevation of a plane that extends coextensively with respective cluster supporting bottom surfaces of such nanowells. In one example, cluster supporting structures defining reaction sites 206 can be provided by nanowells. In other examples, cluster supporting structures defining reaction sites 206 can include, e.g., posts, pads, ridges, channels, and/or layers of a multilayer material. A cluster herein such as cluster C1, and cluster C2, can be included within a cluster location of a reaction site 206. A cluster location herein can refer to a location of a reaction site 206 at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure that includes an aperture for selectively transmitting light of a certain polarity.

In one example, the first reaction site 206 at A by operation of the first aperture configuration can selectively transmit light rays of excitation light 101 of a first polarization and can selectively block light rays of excitation light 101 of a second polarization. The second reaction site 206 at B by operation of the described second aperture configuration of aperture 207 can selectively transmit light rays of excitation light 101 of the second polarization and can selectively block light rays of excitation light 101 of the first polarization. In one example, the first reaction site 206 at A selectively transmitting light rays of excitation light 101 of a first polarization can include selectively transmitting light rays of excitation light 101 of the first polarization to a cluster location of the first reaction site 206 at A. In one example, the second reaction site 206 at B selectively transmitting light rays of excitation light 101 of a second polarization can include selectively transmitting light rays of excitation light 101 of the second polarization to a cluster location of the second reaction site 206 at B. A cluster location herein can refer to a location at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure that includes an aperture for selectively transmitting light of a certain polarity.

In another aspect, reaction structure 260 can be configured to define the first reaction site 206 and the second reaction site 206 by being provided in accordance with a particular fabrication method. In one aspect, light energy exciter 10 for generating excitation light 101 can be configured to generate excitation light 101 provided by polarized excitation light. Light energy exciter 10 can be configured so that at a first time period, light energy exciter 10 radiates excitation light 101 of a first polarity and further so that at a second time period, light energy exciter 10 radiates excitation light 101 having a second polarity different from the first polarity. In one example, the first polarity can be provided by X polarized (horizontal polarized) light. In one example, the second polarity can be provided by Y polarized (vertically polarized) light.

Additional aspects of apparatus 100 are set forth in reference to FIG. 2, illustrating a cross-sectional view of detector 200 taken at an elevation of pixel sensors 202. FIG. 2 is a cross-sectional top view looking in the direction of Z axis of the reference coordinate system depicted in FIGS. 1 and 2. In the cross-sectional view of FIG. 2, there are shown as being associated to each respective pixel 201 first and second reaction sites 206. The first and second reaction sites 206 associated to respective pixels 201 in the view of FIG. 2 are shown in dashed in form to indicate that the depicted reaction sites 206 are in the foreground of the view of FIG. 2.

In one example, each respective pixel 201 of detector 200 can have associated thereto first and second reaction sites configured according to the first and second reaction sites at A and B associated to pixel 201 at “C”.

As described in connection with FIG. 1, pixel sensors 202 in combination with light guides 214 can define pixels 201. Referring to reaction sites 206 as seen in the cross-sectional top view of FIG. 2, first and second reaction sites 206 can be associated to each respective pixel 201 of defining the depicted pixel array and each respective pixel sensor 202 defining the depicted pixel array. With further reference to FIG. 2, there are shown width dimension vertically extending planes 2201 and depth dimension vertically extending planes 2202. Width dimension extending vertically extending planes 2201 can be centered on width dimension extending isolation structures 218 as depicted in FIG. 2, and depth dimension extending vertically extending planes 2202 can be centered on depth dimension vertically extending isolation structures 218 as depicted in FIG. 2.

In one aspect, first and second reaction sites 206 associated to a certain pixel and pixel sensor 202 can be aligned to the certain pixel 201 and the certain pixel sensor 202. In one aspect of being aligned, the first and second reaction sites 206 can be disposed within a boundary delimited by a pair of adjacent width dimension vertically extending planes 2201 and a pair of adjacent depth dimension vertically extending planes 2202 as depicted in FIG. 2. The pixel array defined by pixel sensors 202 and pixels 201 which can be delimited by adjacent width dimension vertically extending planes 2201 and adjacent depth dimension vertically extending planes 2202 can define pixel positions A1-F4 depicted in FIG. 2. Each respective pixel 201 and pixel sensor can have a pixel position, PX, PY which can be referenced as an X dimension position in combination with a Y dimension position. Reaction structure 260 can be divided into pixel positions, wherein respective pixel positions of reaction structure 260 map to respective pixel positions of the pixel array defined by pixels 201. Like the pixel positions of the defined pixel array, the pixel positions of reaction structure 260 can be delimited by adjacent width dimension vertically extending planes 2201 and adjacent depth dimension vertically extending planes 2202. The depicted pixel positions serve as pixel positions for reaction sites 206 formed on reaction structure 260 (FIG. 1). It will be seen that a portion of reaction structure 260 having the pixel position PY=m, PX=n can include first and second reaction sites 206 that are disposed over and on, and which are aligned to a pixel 201 of the defined pixel array having the common pixel position PY=m, PX=n. In the view of FIG. 2, there are shown first and second reaction sites 206 disposed at each respective pixel position of pixel positions A1-F4, wherein one pixel position is defined for each respective pixel 201 and pixel sensor 202.

Reaction sites 206 depicted in dashed in form are shown in functional form view in FIG. 2. The reaction sites 206 depicted with a horizontally extending arrow are reaction sites configured to selectively transmit light rays of excitation light 101 of a first polarity and the depicted reaction sites 206 depicted with a vertically extending arrow in FIG. 2 are reaction sites configured to selectively transmit light rays of excitation light 101 of a second polarity, e.g., Y polarity.

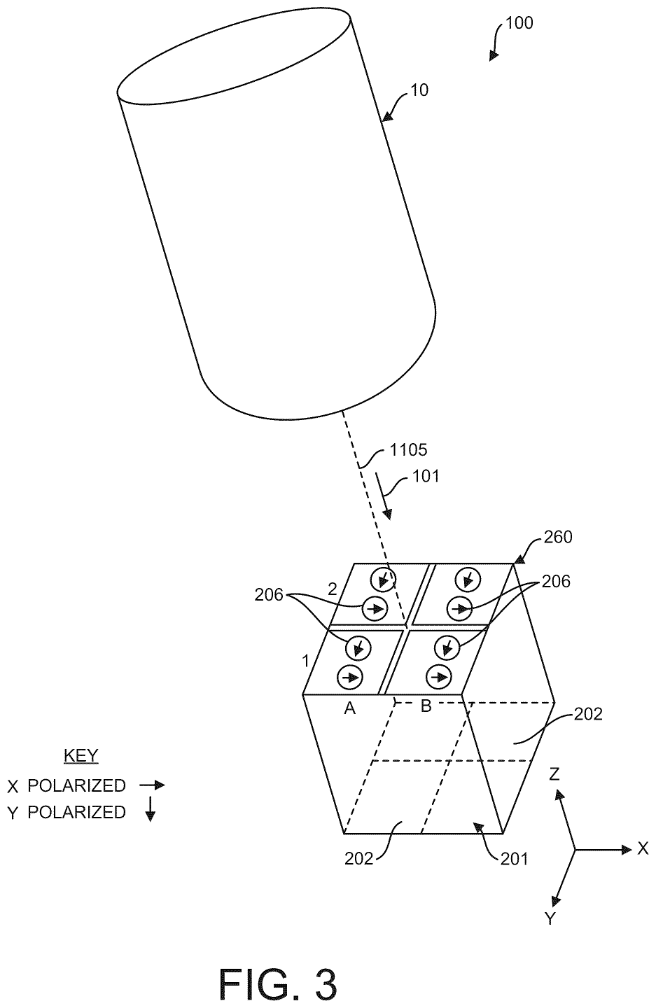

A schematic view of apparatus 100 is shown in FIG. 3. In operation, light energy exciter 10 of apparatus 100 can radiate light rays of excitation light 101 about excitation center axis 1105 toward reaction structure 260 on which there can be defined a plurality of reaction sites 206, and specifically multiple reaction sites per pixel as shown in FIG. 3. As set forth herein, reaction structure 260 can define multiple reaction sites per pixel such as first and second reaction sites 206 per pixel wherein pixels 201 can be defined by pixel sensors 202 in combination with an associated light guide 214 as shown in FIG. 1.

Each respective pixel 201 can have associated thereto first and second reaction sites 206. As set forth in FIG. 3, first reaction site 206 associated to a certain pixel can be configured to selectively transmit light of a first polarity, and a second reaction site 206 of the certain pixel can be configured to selectively transmit excitation light rays defining excitation light 101 of a second polarity. In FIG. 3, respective pixels 201 can each include a first reaction site 206 depicted with a horizontal arrow and a second reaction site depicted with a vertically extending arrow (extending in the direction of the Y axis of the reference coordinate system). Light energy exciter 10 can be configured to emit flood illumination so that light rays defining excitation light 101 can radiate an entirety of detector surface 209 at a top elevation thereof. By radiating flood illumination, light energy exciter 10 can direct polarized light excitation light rays defining excitation light 101 toward each reaction site 206 of reaction structure 260 simultaneously. As set forth herein, a first subset of the reaction sites 206 can transmit, and a plurality of the reaction sites 206 can block the excitation light depending on the polarity of the excitation light 101. At the depicted pixel positions A1-B2, there is shown for each respective pixel position a pixel 201 having a pixel sensor 202 as well as first and second reaction sites 206. According to one example, detector 200 can be provided by a solid-state integrated circuit detector, such as complementary metal oxide semiconductor (CMOS), integrated circuit detector, or a charge coupled device (CCD) integrated circuit detector. Pixel sensors 202, in one example, can be provided in a two-dimensional pixel array having rows and columns of pixels arranged in a grid pattern that is shown in the cross-sectional top view of FIG. 3 taken along the elevation of pixel sensors 202 shown in FIG. 1. In one example, such pixel array can include at least 1 million (1M) pixels, or can include fewer pixels.

As set forth herein, first and second reaction sites 206 associated to a given pixel 201 can either selectively transmit or selectively block light rays of the excitation light 101 depending on the polarity of the light rays defining excitation light 101. In another aspect, first and second reaction sites 206 associated to a given pixel 201 can be configured to exhibit a photonic power transmission ratio in favor of a first reaction site under illumination by excitation light rays of a first polarity and can be configured to exhibit a photonic power transmission ratio in favor of a second reaction site under illumination by excitation light rays of a second polarity. Light energy exciter 10 can be configured to radiate polarized light. In one example, light energy exciter 10 can be configured so that during a first time period, light energy exciter 10 radiates excitation light rays defining excitation light 101 having a first polarity, and further so that during a second time period, light energy exciter 10 radiates excitation light rays defining excitation light 101 having a second polarity. In one example, the first polarity can be an X axis (horizontal polarity), and the second polarity can be a Y axis (vertical polarity). In one example, light energy exciter 10 can radiate polarized light with use of one or more light polarizing filter, with use of reflection, with use of refraction, and/or with use of scattering. Light energy exciter 10 can include one or more light source. The one or more light source can include, e.g., one or more light emitting diode (LED), one or more laser, one or more incandescent light, and/or one or more fluorescent light. In some examples, light energy exciter 10 can include multiple light sources that radiate at different wavelength ranges at different time periods, e.g., green light at a first time period or blue light at second time period. Specific polarities can be combined with specific wavelength ranges. One example is illustrated as follows. At a first time period, light energy exciter 10 can radiate light of a first polarity at a first wavelength range. At a second time period, light energy exciter 10 can radiate light of the first polarity at a second wavelength range. At a third time period, light energy exciter 10 can radiate light of a second polarity at the first wavelength range. At a fourth time period, light energy exciter 10 can radiate light of the second polarity at the wavelength range.

In one example, light energy exciter 10 can be configured to include a first polarizing light filter and a second polarizing light filter. When a first polarizing light filter is active, light energy exciter 10 can radiate excitation light 101 of a first polarity. Light energy exciter 10 can be configured so that when a second light polarizing filter is active, light energy exciter 10 can radiate polarized light of the described second polarity.

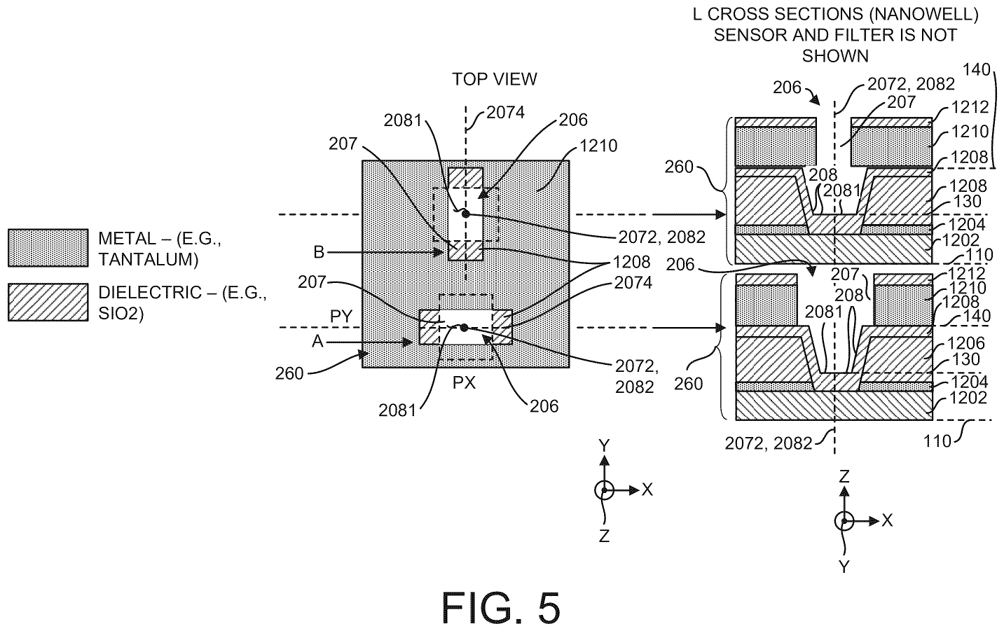

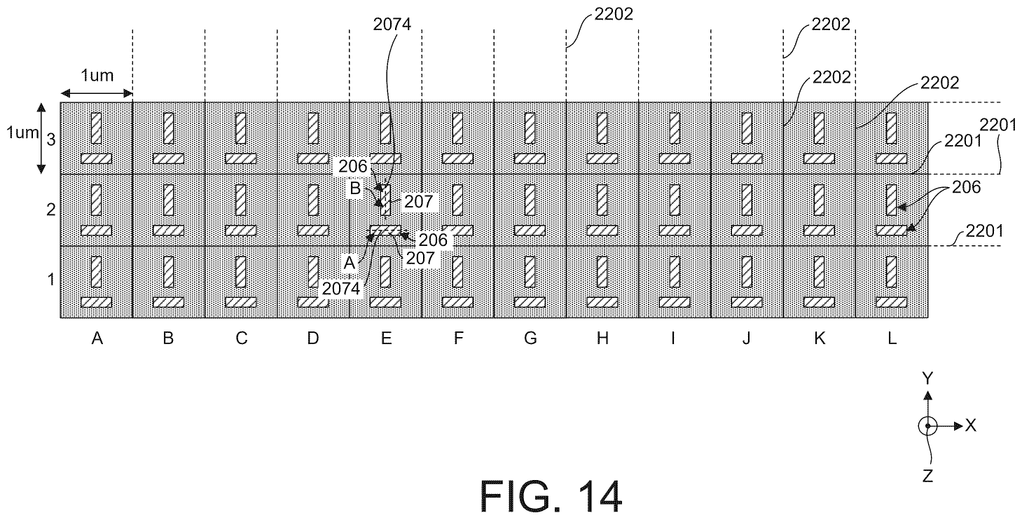

FIG. 5 illustrates top and cross-sectional views illustrating of first and second reaction sites 206 associated to a representative certain pixel of the pixel array depicted in FIG. 2. Referring to the top view of FIG. 5, there are shown first and second reaction sites 206, which can be differently configured. The first reaction site 206 at A can include horizontally extending aperture that extends lengthwise in a direction parallel to the X axis of the depicted reference coordinate system. The second reaction site 206 at B can include an elongated rectangular aperture that extends lengthwise in a direction parallel to the Y axis of the reference coordinate system. The first and second reaction sites 206 can be at an arbitrary pixel position PX, PY as described in FIG. 2 which is associated to and aligned to a certain pixel 201 at a pixel position in common with the arbitrary pixel position of the pixel array depicted in FIG. 2. In one example, each pixel position of reaction structure 260 can be commonly configured, except that in some cases, as set forth in referenced to FIGS. 14-20 a relative orientation between first and second reaction sites 206 at adjacent pixel positions can be varied. In one example, the first and second reaction sites 206 at each respective pixel position of reaction structure 260 can have common dimensions, e.g., common length dimensions, and common width dimensions.

The first reaction site 206 at A in FIG. 5 having horizontally (X axis parallel) extending aperture 207 can be configured to selectively transmit light rays of excitation light 101 of a first polarity, e.g., X polarity (horizontal polarity) and the second reaction site 206 at B having depth wise vertically (Y axis parallel) extending aperture 207 can be configured to selectively transmit light rays of excitation light 101 of a second polarity, e.g., Y polarity (horizontal polarity).

In one aspect, reaction sites 206 including first reaction site 206 at A and reaction site 206 at B can include respective apertures 207. Apertures 207, in one example, can be defined by layer 1210, which can be provided by metal material, e.g., tantalum, gold, silver, or copper, or the like. Referring to the top and cross-sectional views of FIG. 5, the top cross-sectional view of reaction structure 260 can be taken along the elevation of layer 1210.

Referring to the top view of FIG. 5, horizontally oriented aperture 207 at A can be configured to selectively transmit light rays of excitation light 101 of a first polarity (e.g., X polarized light) and can be configured to selectively block light rays of excitation light 101 of a second polarity (e.g., Y polarized light). The aperture 207 at B can be configured to selectively transmit light rays of excitation light 101 of the second polarity, e.g., Y polarized light, and can be configured to selectively block light rays of excitation light 101 of the first polarity, e.g., X polarized light. Aperture 207 at A and aperture 207 at B can from a top view can define elongated rectangles. Elongated rectangle aperture 207 at A and elongated rectangle aperture 207 at B can have respective length dimensions and width dimensions. The length dimension of aperture 207 defining reaction site 206 at A can be oriented horizontally to extend in parallel with the X axis of the depicted reference coordinate system. The length dimension of aperture 207 defining reaction site 206 at B can be oriented vertically depth wise in the depicted top view perspective and can extend in parallel with the Y axis of the depicted reference coordinate system.

In one example with reference to the top cross-sectional view of FIG. 5 and side cross-sectional view of FIG. 5, a vertically extending center axis 2082 of respective nanowells 208 can be co-located with vertically extending center axes 2072 of apertures 207 of the respective reaction sites 206 at locations A and B, respectively. Further, vertically extending center axes 2082 and 2072 at A and B respectively can extend through a common certain one pixel 201 and a common certain one pixel sensor 202 as are shown in FIG. 1. As seen in FIG. 5, an aperture 207 of each reaction site 206 can be aligned with a respective nanowell 208 of the reaction site 206. In one aspect of being aligned, the aperture 207 and the nanowell 208 can include co-located vertically extending axes 2072 and 2082.

Fabrication details of reaction structure 260, according to one example, are described with reference to the cross-sectional side view of FIG. 5. Reaction structure 260 can be defined by a dielectric stack as shown in the right side of FIG. 5. In the right-hand side of FIG. 5, there is depicted cross-sectional side views for the respective volumes depicted at A and B respectively (the dashed in squares) on the left-hand side of FIG. 5.

In one example, for providing reaction structure 260 as depicted in FIG. 1, there can be deposited on the pixel array defined by pixels as shown in FIG. 1 and FIG. 2 a plurality of layers defining a dielectric stack. Reaction structure 260, as shown in FIG. 5 can include layer 1202, layer 1204, layer 1206, layer 1208, layer 1210, and layer 1212 to define a dielectric stack. The dielectric stack can include a plurality of dielectric layers and can integrate one or more metal layers. Layer 1202, layer 1206, layer 1208, and layer 1212, according to the example of FIG. 5, can be provided by dielectric layers, and layer 1204 and layer 1210 can be provided by metal layers. Layer 1204 can be provided to attenuate crosstalk between adjacent pixel positions. As shown by the side cross-sectional view right hand side of FIG. 5, reaction structure 260 can further include layer 1212 provided by a dielectric layer to protect layer 1210, which can be provided by metal.

Examples herein recognize that dimensions of structures defining reaction site 206 at A and reaction site 206 at B and materials defining such structures can impact performance of the respective reaction sites 206 in terms of selectively transmitting or selectively blocking polarized light and in terms of providing the described photonic power transmission ratios in favor of a first reaction site 206 at A or a second reaction site 206 at B as set forth herein.

Referring to apparatus 100 as shown in FIG. 5, a top of pixels defining a pixel array (e.g., as shown in FIGS. 1 and 2) can be defined at elevation 110. Elevation 110 can also define a bottom elevation of reaction structure 260.

Elevation 130 can define a cluster supporting surface of reaction structure 260 according to one example. Where reaction structure 260 includes nanowells 208 as depicted in FIG. 5, elevation 130 can define an elevation of a plane that extends coextensively with respective cluster supporting bottom surfaces of such nanowells. In one example, as depicted in FIG. 5, cluster supporting structures defining reaction sites 206 can be provided by nanowells. In other examples, cluster supporting structures defining reaction sites 206 can include, e.g., posts, pads, ridges, channels, and/or layers of a multilayer material. A cluster herein such as cluster C1, and cluster C2, can be included within a cluster location of a reaction site 206. A cluster location herein can refer to a location of a reaction site 206 at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure (layer 1210 in the example of FIG. 5) that includes an aperture 207 for selectively transmitting light of a certain polarity.

In one example, the first reaction site 206 at A by operation of the first aperture configuration can selectively transmit light rays of excitation light 101 of a first polarization and can selectively block light rays of excitation light 101 of a second polarization. The second reaction site 206 at B by operation of the described second aperture configuration of aperture 207 can selectively transmit light rays of excitation light 101 of the second polarization and can selectively block light rays of excitation light 101 of the first polarization. In one example, the first reaction site 206 at A selectively transmitting light rays of excitation light 101 of a first polarization can include selectively transmitting light rays of excitation light 101 of the first polarization to a cluster location of the first reaction site 206 at A. In one example, the second reaction site 206 at B selectively transmitting light rays of excitation light 101 of a second polarization can include selectively transmitting light rays of excitation light 101 of the second polarization to a cluster location of the second reaction site 206 at B. A cluster location herein can refer to a location at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure (layer 1210 in the example of FIG. 5) that includes an aperture 207 for selectively transmitting light of a certain polarity.

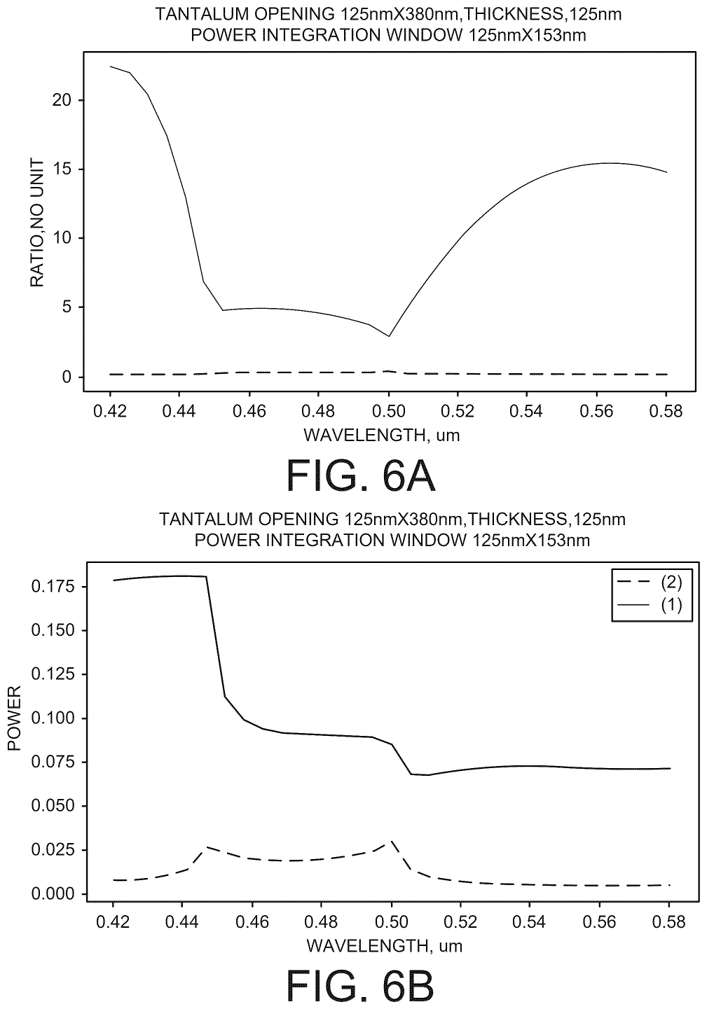

FIGS. 6A-8B depict simulated performance of reaction site 206 at A and reaction site 206 at B under various configuration parameter values. In one example, simulations set forth herein can be performed with use of optical system simulation software, such as the optical system simulation software OPTICSTUDIO® available from Zemax LLC.

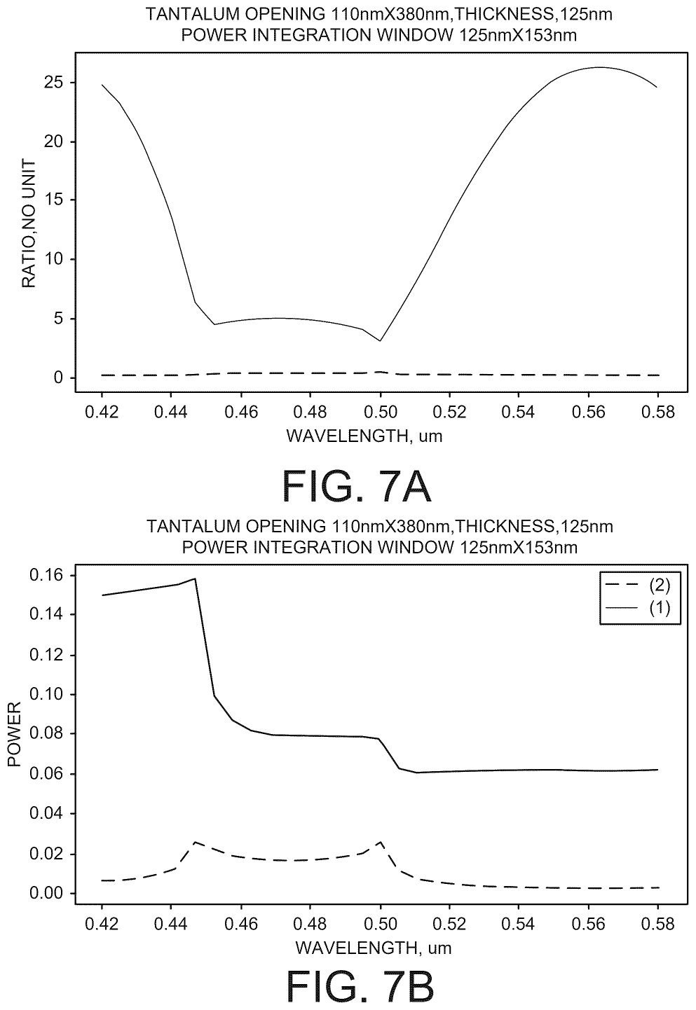

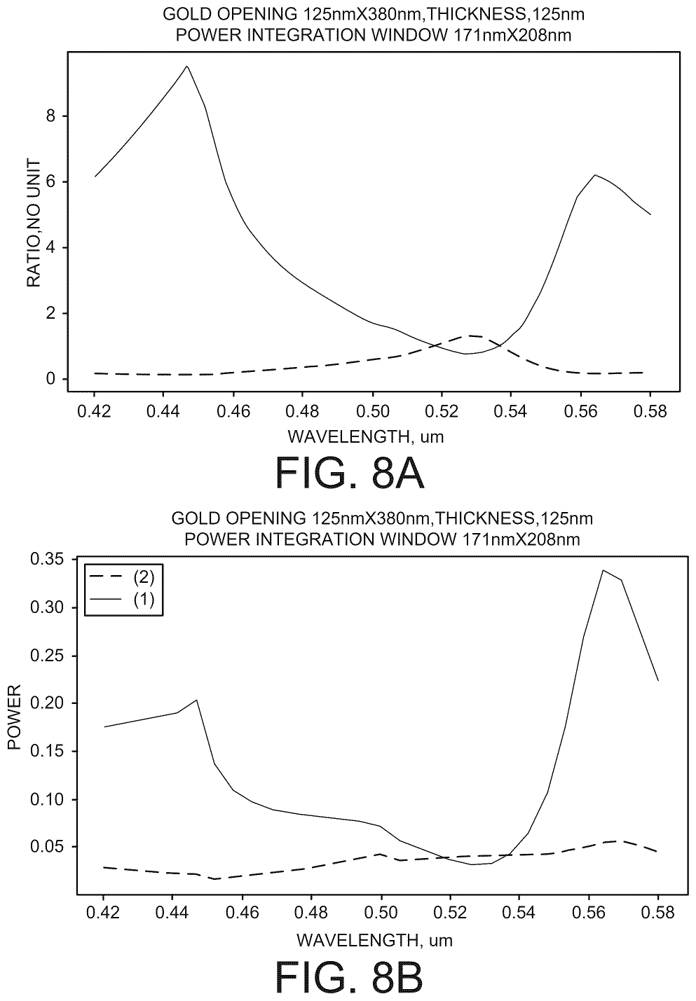

In FIGS. 6A-8C, the power integration window having depicted dimensions can refer to an area corresponding to and about nanowell bottom surface 2081 as depicted in FIG. 5 and the tantalum opening dimensions (an example material) can refer to the dimensions of aperture 207 at location A and location B respectively, defining the respective reaction sites 206 at the respective locations A and B. FIG. 6B, FIG. 7B, and FIG. 8B illustrate respective power levels of transmitted photons through the aperture 207 at A and at B respectively as shown in FIG. 5 in the case that light energy exciter 10 is controlled to radiate light rays of excitation light 101 of the described first polarity (X polarized light). In such a scenario, the first reaction site 206 at A can be expected to selectively transmit light rays of excitation light of the first polarity, and reaction site 206 at B can be expected to selectively block light rays of excitation light 101 of the described second polarity.

Various structures defining reaction site 206 at A and reaction site 206 at B can be adjusted for purposes of tuning performance of the reaction sites 206 at A and B. FIGS. 6A and 6B illustrate that with use of the specified structural parameters including with apertures 207 having widths of 125 nm, the reaction sites 206 at A and B (FIG. 1, FIG. 5) can exhibit the performance as set forth in FIGS. 6A and 6B. In FIGS. 6B, 7B, 8B, 9B, 10B, and 11B, the lower dashed curve depicts photon transmission power thorough second reaction site 206 at B (FIG. 5) under illumination by excitation light 101 of a first polarity and the upper solid curve depicts photon transmission power thorough first reaction site 206 at A under illumination by excitation light 101 of the first polarity. FIGS. 6A, 7A, 8A, 9A, 10A, and 11A depict a ratio of photonic power transmission through a first reaction site 206 at A relative to a second rection site at B (FIG. 5) under illumination by excitation light 101 of the first polarity. In the simulations depicted in FIGS. 6A-11B, the first and second reaction sites 206 at A and B have common aperture dimensions and material characteristics, but have different orientations (first reaction site 206 at A having longitudinally extending center axis 2074 extending in parallel with the X axis of the depicted reference coordinate system, second reaction site 206 at B having longitudinally extending center axis 2074 extending in parallel with the Y axis of the depicted reference coordinate system).

Referring to FIGS. 6A and 6B, photons transmitted through reaction site 206 at A relative to photons transmitted through reaction site 206 at B can exhibit a power ratio of at least about 3 throughout all operating regions of from about 420 nm to about 580 nm. Referring to FIG. 6A, the depicted reaction structure 260 can exhibit a photonic power transmission ratio of above about 20 for the operating region of from about 420 nm to about 430 nm and can exhibit a photonic power transmission ratio of above about 10 for the excitation light operating region of from about 530 nm to about 550 nm.

Referring to FIGS. 7A and 7B, the performance of reaction structure 260 can be enhanced by decreasing the width of aperture 207 at A and the aperture 207 at B. FIGS. 7A and 7B depict photonic power transmission through apertures 207 at A and B where the width of the respective apertures 207 is decreased to feature a width of about 110 nm.

Referring to FIG. 7A with reaction structure 260 modified as described, reaction structure 260 can exhibit a photon transmission power ratio between reaction site 206 at A and reaction site 206 at B of above about 20 in the operating excitation light region wherein light energy exciter 10 radiates excitation light at wavelengths at or above 540 nm and can exhibit a photonic power transmission ratio of at or above 20 in the operating region wherein light energy exciter 10 radiates excitation light in the wavelength range of about 440 nm or less.

Referring to the wavelength coordination diagram of FIG. 4, a wavelength of radiated excitation light 101 can be coordinated with optimally performing operating regions that are depicted in photon transmission diagrams of FIGS. 6A-8C. For example, referring to FIGS. 6A, 7A, and 8A, the photonic power transmission ratio between reaction site 206 at A and reaction site 206 at B can be at or above about 10 (at least about 10) for the excitation center wavelength of about 525 nm as depicted in FIG. 4 (above about 10 in the example of FIG. 6A, above about 15 in the example of FIG. 7A).

FIGS. 8A and 8B depict performance of reaction structure 260 when dimensions of a power integration window are decreased and when material providing layer 1210 defining aperture 207 is changed from tantalum to gold. The power integration window can refer to an area corresponding to and about the surface area of bottom surface 2081 of nanowell 208. As depicted in FIGS. 8A and 8B, increasing a size of the described power integration window and changing a material defining aperture 207 can alter performance characteristics of reaction structure 260. As depicted in FIG. 8A, a maximum photonic power transmission ratio between reaction site 206 at A and reaction site 206 at B can be reduced from a maximum of greater than about 20 in the case of the examples of FIGS. 6A and 7A and to a maximum of about 9 in the example depicted in FIG. 8A (at the operating region wherein a wavelength of excitation light is radiated at about 440 nm). However, with use of the configuration depicted in FIGS. 8A and 8B an overall transmission of photons can be increased.

Referring to FIGS. 8A and 8B, reaction structure 260 can continue to exhibit useful operating regions, although a photonic power transmission ratio between reaction site 206 at A and reaction site 206 at B can be reduced. For use with the design depicted in FIGS. 8A and 8B, excitation light 101 of light energy exciter 10 for achieving a photonic power transmission ratio between a first reaction site at A and a second reaction site at B of about 5 can be red shifted, e.g., from about 525 nm to about 570 nm.

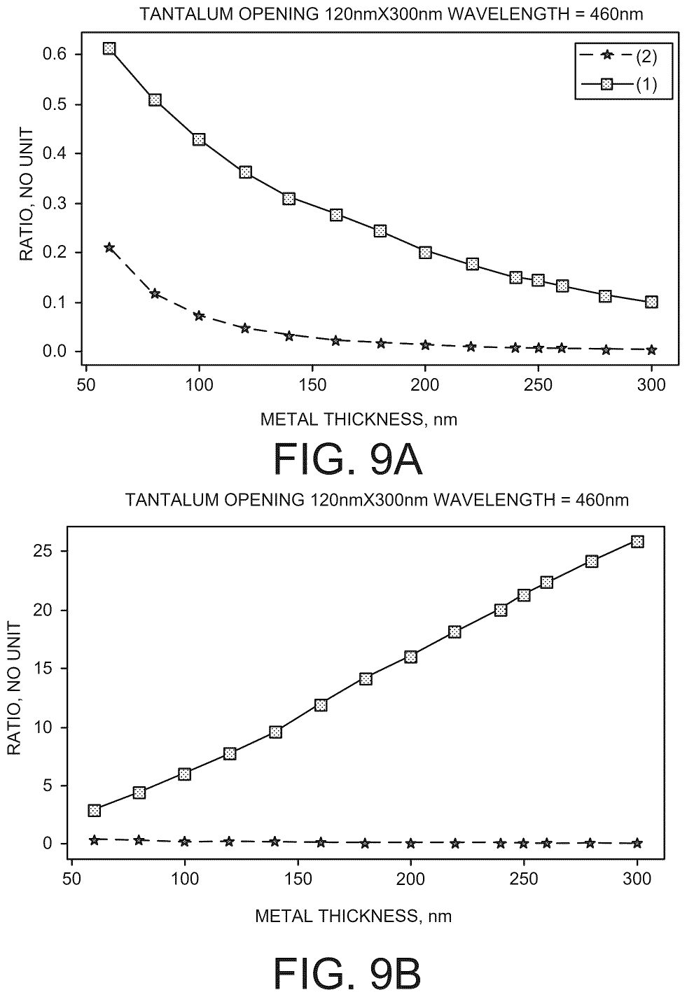

FIGS. 9A and 9B depict simulation results associated to increasing widths of aperture 207 as depicted in FIG. 5. In the depicted simulation of FIG. 9A and FIG. 9B, simulated first and second reaction sites 206 as shown at A and B of FIG. 5 can be associated to respective ones of pixel positions PX, PY, as shown in FIG. 2, wherein each respective pixel position is defined by and aligned with the location of a respective pixel 201 of the depicted pixel array of FIG. 2. In the simulation depicted in FIGS. 9A and 9B respective pixel positions PX, PY can have pixel dimensions of about 0.7 um×0.7 um (each pixel position A1-F4 depicted in FIG. 2 can have the dimensions 0.7 um×0.7 um from a top view depicted in FIG. 2). In the simulation depicted in FIGS. 9A and 9B, it can be seen that increasing a thickness of layer 1210 defining aperture 207 can decrease photon transmission through apertures 207 and locations A and B respectively (FIG. 5) but can increase a photonic power transmission ratio between first reaction site 206 at A and second reaction site at B under illumination by light rays of excitation light 101 of a first polarity.

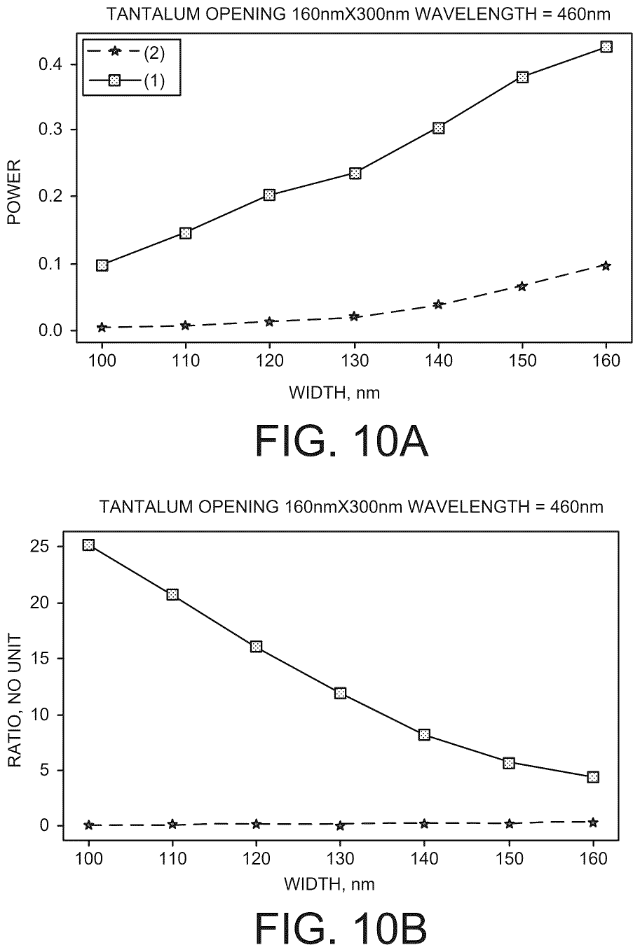

FIGS. 10A and 10B depict simulation results associated to increasing the widths of aperture 207 as depicted in FIG. 5. In the depicted simulation of FIG. 10A and FIG. 10B, simulated first and second reaction sites 206 at A and B as depicted in FIG. 5 can be associated to respective ones of pixel positions pX, pY, as shown in FIG. 2, wherein each respective pixel position is defined by and aligned with the location of a respective pixel 201 of the depicted pixel array of FIG. 2. In the simulation depicted in FIGS. 10A and 10B respective pixel positions PX, PY can have pixel dimensions of about 0.7 um×0.7 um (each pixel position A1-F4 depicted in FIG. 2 can have the dimensions 0.7 um×0.7 um from a top view depicted in FIG. 2). In the simulation depicted in FIGS. 10A and 10B, it can be seen that increasing a width of aperture 207 can increase photon transmission through apertures 207 at locations A and B respectively (FIG. 5) but can decrease a photonic power transmission ratio between first reaction site 206 at A and second reaction site at B under illumination by light rays of excitation light 101 of a first polarity. In the simulation depicted in FIG. 10B, a photonic power transmission ration between first and second reaction sites 206 at A and B of FIG. 5 under illumination by excitation light rays of excitation light 101 of a first polarity of about 10 can be achieved with use of an aperture width of aperture 207 of about 130 nm. In the simulation depicted in FIG. 10B, a photonic power transmission ration between first and second reaction sites 206 at A and B of FIG. 5 under illumination by excitation light rays of excitation light 101 of a first polarity of about 15 can be achieved with use of an aperture width of aperture 207 of about 120 nm. In the simulation depicted in FIG. 10B, a photonic power transmission ration between first and second reaction sites 206 at A and B of FIG. 5 under illumination by excitation light rays of excitation light 101 of a first polarity of about 20 can be achieved with use of an aperture width of aperture 207 of about 110 nm. Thus, a photonic power transmission ratio can be increased by decreasing a width of aperture 207.

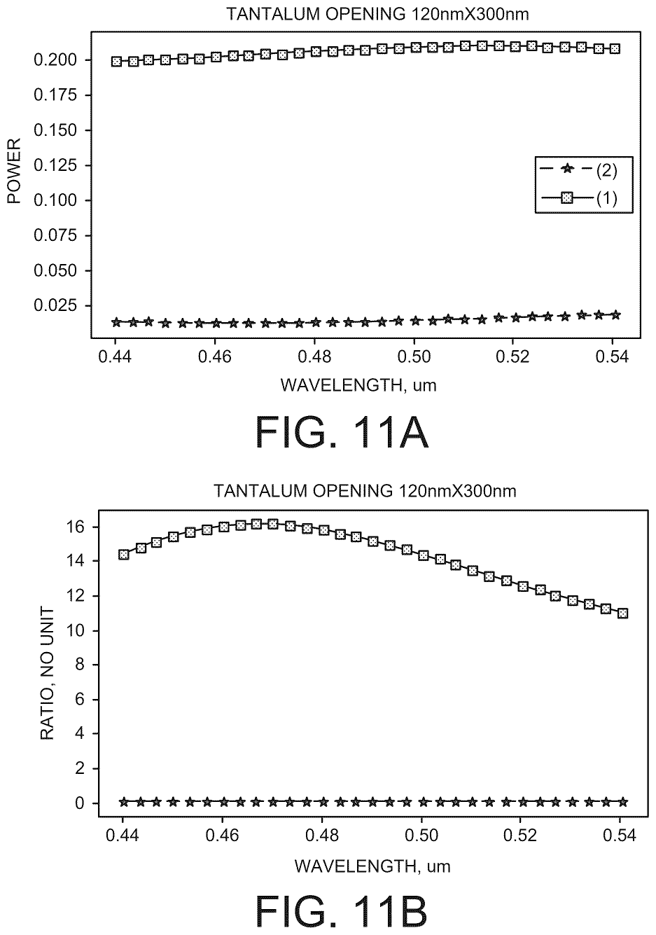

FIGS. 11A and 11B depict performance of reaction structure 260 with aperture 207 having a thickness of about 200 nm under a range of excitation wavelengths defining excitation light 101. Comparing FIG. 11A-11B to FIGS. 6A-8B, it is seen that with a larger thickness of aperture 207, photonic transmission can be more stable across a span of wavelengths defining excitation light 101. In the simulation depicted in FIGS. 11A and 11B, a photonic transmission power ratio in favor of reaction site 206 at A relative to reaction site at B (FIG. 5) can peak at about 470 nm but can remain substantially stable (varying between a minimum of about 10 and a maximum of about 14) throughout a range of wavelengths of between about 440 nm to about 540 nm.

In one aspect, as set forth in reference to FIGS. 6A-11B, first and second reaction sites 206 associated to a certain pixel 201 can be configured so that under illumination by excitation light rays of excitation light 101 of a first polarity and then a second polarity, the reaction sites can feature differentiated photonic power transmission ratios. The photonic power transmission ratios depicted in FIGS. 6A-11B can be in arbitrary photonic power transmission units.

Implementations herein recognize that first and second reaction sites 206 at A and B in FIG. 5 having performance characteristics as summarized in FIG. 6A-11B under illumination by excitation light 101 of a first polarity can have inverse characteristics under illumination by excitation light 101 of a second polarity, with second reaction site 206 at B exhibiting the depicted characteristics of first reaction site at A and with first reaction site 206 at A exhibiting the depicted characteristics of second reaction site 206 at B.

There is set forth herein, in one aspect, a plurality of pixels; a first reaction site associated to a pixel of the plurality of pixels; a second reaction site associated to the pixel; wherein the first reaction site and the second reaction site are configured so that under illumination by excitation light of a first polarity, the first reaction site and the second reaction site exhibit a photonic power transmission ratio in favor of the first reaction site, and further so that so that under illumination by excitation light of a second polarity, the second reaction site and the first reaction site exhibit a photonic power transmission ratio in favor of the second reaction site. In one example, the photonic power transmission ratio in favor of the first reaction site under illumination by excitation light of the first polarity can be at least about 2:1, and the photonic power transmission ratio in favor of the second reaction site under illumination by excitation light of the second polarity can be at least about 2:1. In one example, the photonic power transmission ratio in favor of the first reaction site under illumination by excitation light of the first polarity can be at least about 5:1, and the photonic power transmission ratio in favor of the second reaction site under illumination by excitation light of the second polarity can be at least about 5:1. In one example, the photonic power transmission ratio in favor of the first reaction site under illumination by excitation light of the first polarity can be at least about 10:1, and the photonic power transmission ratio in favor of the second reaction site under illumination by excitation light of the second polarity can be at least about 10:1.

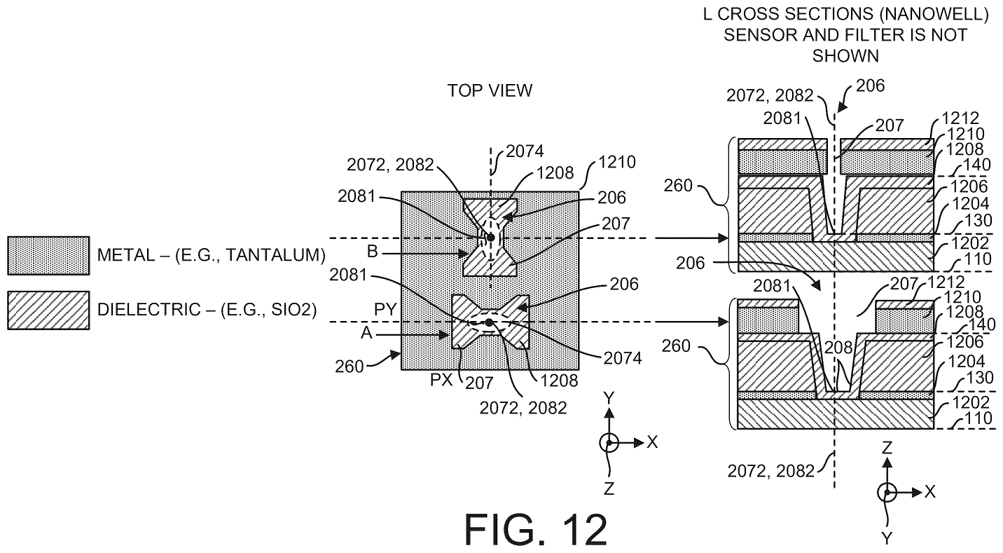

Another example of reaction structure 260 is illustrated in FIG. 12. In the example of FIG. 12, reaction structure 260 can include for each pixel position of the pixel array depicted at FIG. 2 first reaction site 206 at A and second reaction site 206 at B. In the example of FIG. 12, apertures 207 from a top view can include an hourglass shape. Apertures 207 defined by layer 1210, which can be formed of or comprise metal, can be elongated as shown to feature a length dimension and a width dimension.

To provide the hourglass shape as depicted in FIG. 12 from a top view, the width dimension can be reduced at a center of the aperture 207 from a top view so that respective apertures 207 can have relatively larger widths at ends thereof and a relatively smaller width at a middle section thereof.

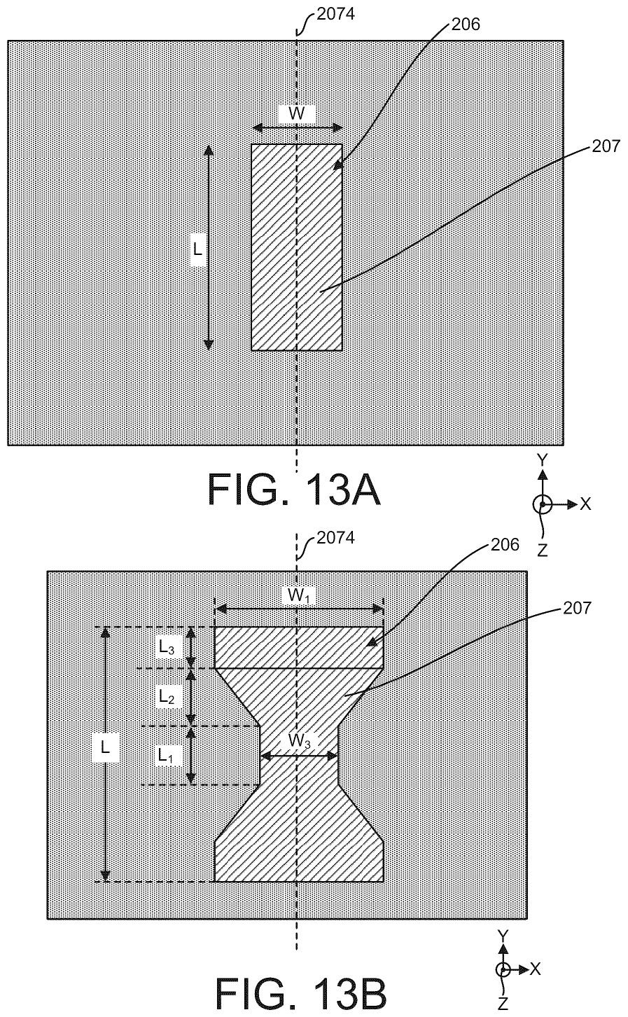

FIG. 12 illustrates top and cross-sectional views illustrating first and second reaction sites 206 associated to a representative certain pixel of the pixel array depicted in FIG. 2. Referring to the top view of FIG. 12, there are shown first and second reaction sites 206, which can be differently configured. The first reaction site 206 at A can include a horizontally extending aperture that extends lengthwise in a direction parallel to the X axis of the depicted reference coordinate system. The second reaction site 206 at B can include an elongated rectangular aperture that extends lengthwise in a direction parallel to the Y axis of the reference coordinate system. The first and second reaction sites 206 can be at an arbitrary pixel position PX, PY as described in FIG. 2 which is associated to and aligned to a certain pixel 201 at a pixel position in common with the arbitrary pixel position of the pixel array depicted in FIG. 2. In one example, each pixel position of reaction structure 260 can be commonly configured, except that in some cases, as set forth in referenced to FIGS. 14-20 a relative orientation between first and second reaction sites 206 at adjacent pixel positions can be varied. In one example, the first and second reaction sites 206 at each respective pixel position of reaction structure 260 can have common dimensions, e.g., common length dimensions, and common width dimensions, and common additional dimensions which are set forth herein in connection with FIG. 13B.

The first reaction site 206 at A in FIG. 12 having horizontally extending aperture 207 can be configured to selectively transmit light rays of excitation light 101 of a first polarity, e.g., X polarity (horizontal polarity) and the second reaction site 206 at B having depth wise vertically extending aperture 207 can be configured to selectively transmit light rays of excitation light 101 of a second polarity, e.g., Y polarity (horizontal polarity).

In one aspect, reaction sites 206 including first reaction site 206 at A and reaction site 206 at B can include respective apertures 207. Apertures 207, in one example, can be defined by layer 1210, which can be provided by metal material, e.g., tantalum, gold, silver, or copper, or the like. Referring to the top and cross-sectional views of FIG. 12, the top cross-sectional view of reaction structure 260 can be taken along the elevation of layer 1210.

Referring to the top view of FIG. 12, horizontally oriented aperture 207 at A can be configured to selectively transmit light rays of excitation light 101 of a first polarity (e.g., X polarized light) and can be configured to selectively block light rays of excitation light 101 of a second polarity (e.g., Y polarized light). The aperture 207 at B can be configured to selectively transmit light rays of excitation light 101 of the second polarity, e.g., Y polarized light, and can be configured to selectively block light rays of excitation light 101 of the first polarity, e.g., X polarized light.

Aperture 207 at A and aperture 207 at B can from a top view define elongated hourglass shapes having reduced widths at their middle regions. Elongated hourglass aperture 207 at A and elongated hourglass aperture 207 at B can have respective length dimensions and width dimensions. The length dimension of aperture 207 defining reaction site 206 at A can be oriented horizontally to extend in parallel with the X axis of the depicted reference coordinate system. The length dimension of aperture 207 defining reaction site 206 at B can be oriented vertically depth wise in the depicted top view prospective and can extend in parallel with the Y axis of the depicted reference coordinate system.

In one example with reference to the top cross-sectional view of FIG. 12, respective vertically extending center access 2082 of respective nanowells 208 can be co-located with vertically extending center axes 2072 of apertures 207 of the respective reaction sites 206 at locations A and B, respectively. Further, vertically extending center axes 2082 and 2072 at A and B respectively can extend through a common certain one pixel 201 and a common certain one pixel sensor 202 as are shown in FIG. 1. As seen in FIG. 12, an aperture 207 of each reaction site 206 can be aligned with a respective nanowell 208 of the reaction site 206. In one aspect of being aligned, the aperture 207 and the nanowell 208 can include co-located vertically extending axes 2072 and 2082.

Fabrication details of reaction structure 260, according to one example, are described with reference to the cross-sectional side view of FIG. 12 (right side). Reaction structure 260 can be defined by a dielectric stack as shown in the right side of FIG. 12. In the right-hand side of FIG. 12, there is depicted cross-sectional side views for the respective volumes depicted at A and B respectively on the left-hand side of FIG. 12.

In one example, there can be deposited on the pixel array defined by pixels as shown in FIG. 1 and FIG. 2 a plurality of layers defining a dielectric stack. Reaction structure 260 can include layer 1202, layer 1204, layer 1206, layer 1208, layer 1210, and layer 1212 to define a dielectric stack. The dielectric stack can include a plurality of dielectric layers and can integrate one or more metal layers. Layer 1202, layer 1206, layer 1208, and layer 1212, according to the example of FIG. 12, can be provided by dielectric layers, and layer 1204 and layer 1210 can be provided by metal layers. Layer 1204 can be provided to attenuate crosstalk between pixels of adjacent pixel positions. As shown by the side cross-sectional view right hand side of FIG. 12, reaction structure 260 can further include layer 1212 provided by a dielectric layer to protect layer 1210, which can be provided by metal.

Referring to apparatus 100 as shown in FIG. 12, a top of pixels defining a pixel array (e.g., as shown in FIGS. 1 and 2) can be defined at elevation 110. Elevation 110 can also define a bottom elevation of reaction structure 260.

Elevation 130 can define a cluster supporting surface of reaction structure 260 according to one example. Where reaction structure 260 includes nanowells 208 as depicted in FIG. 12, elevation 130 can define an elevation of a plane that extends coextensively with respective cluster supporting bottom surfaces of such nanowells. In one example, as depicted in FIG. 12, cluster supporting structures defining reaction sites 206 can be provided by nanowells. In other examples, cluster supporting structures defining reaction sites 206 can include, e.g., posts, pads, ridges, channels, and/or layers of a multilayer material. A cluster herein such as cluster C1, and cluster C2, can be included within a cluster location of a reaction site 206. A cluster location herein can refer to a location of a reaction site 206 at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure (layer 1210 in the example of FIG. 12) that includes an aperture 207 for selectively transmitting light of a certain polarity.

In one example, the first reaction site 206 at A by operation of the first aperture configuration can selectively transmit light rays of excitation light 101 of a first polarization and can selectively block light rays of excitation light 101 of a second polarization. The second reaction site 206 at B by operation of the described second aperture configuration of aperture 207 can selectively transmit light rays of excitation light 101 of the second polarization and can selectively block light rays of excitation light 101 of the first polarization. In one example, the first reaction site 206 at A selectively transmitting light rays of excitation light 101 of a first polarization can include selectively transmitting light rays of excitation light 101 of the first polarization to a cluster location of the first reaction site 206 at A. In one example, the second reaction site 206 at B selectively transmitting light rays of excitation light 101 of a second polarization can include selectively transmitting light rays of excitation light 101 of the second polarization to a cluster location of the second reaction site 206 at B. A cluster location herein can refer to a location at which a cluster can be located. A cluster location of a reaction site 206 in one example can be defined between elevation 130 and elevation 140. Elevation 130 can define a cluster supporting surface of reaction structure 260 according to one example. Elevation 140 can delimit a top of a cluster location according to one example. Elevation 140 according to one example can be defined at a bottom of an aperture defining structure (layer 1210 in the example of FIG. 12) that includes an aperture 207 for selectively transmitting light of a certain polarity.

In reference to FIGS. 5 and 12, there is set forth herein an apparatus, wherein a first reaction site 206 at A and second reaction site 206 at B include respective first and second elongated apertures 207 configured so that under illumination by excitation light of a first polarity, the first reaction site 206 at A and the second reaction site 206 at B exhibit a photonic power transmission ratio in favor of the first reaction site 206 at A, and further so that under illumination by excitation light of a second polarity, the second reaction site 206 at B and the first reaction site 206 at A exhibit a photonic power transmission ratio in favor of the second reaction site 206 at B, the first elongated aperture 207 having a longitudinally extending center axis 2074 extending in a first orientation in parallel with an X-axis of a reference coordinate system, the second elongated aperture 207 having a longitudinally extending center axis 2074 extending in a second orientation in parallel with an Y-axis of the reference coordinate system, wherein the Y-axis is orthogonal to the X-axis.

FIGS. 13A and 13B depict further dimensional parameters of the reaction site 206 depicted in the example of FIG. 5 and the reaction site 206 as depicted in the example of FIG. 12. In the case of the rectangular aperture 207 as depicted in FIG. 13A, first and second dimensional parameters can be subject to adjustment for adjusting performance of aperture 207, namely the length L and the width W.

In the case of an hourglass aperture 207 as depicted in FIG. 13B (where the overall length L=L1+2L2+2L3), five dimensional parameters can be subject to adjustment, namely the length dimensional parameters L1, L2, and L3 and the width dimensional parameters W1 and W2, where W1 is the maximal width of aperture 207 at ends thereof and W2 is the minimal width of aperture 207 at a middle region of aperture 207.

Aperture 207 of FIG. 13A can include longitudinally extending center axis 2074 and aperture 207 of FIG. 13B can include longitudinally extending center axis 2074. For selectively transmitting X polarized light, longitudinal center axis 2074 of aperture 207 depicted in FIG. 13A can extend in parallel with X axis of the depicted reference coordinate system of FIG. 5. For selectively transmitting Y polarized light, longitudinal center axis 2074 of aperture 207 depicted in FIG. 10B can extend in parallel with Y axis of the depicted reference coordinate system of FIG. 5.

FIGS. 14-20 depict alternative arrangements of reaction sites 206 associated to different pixel positions of reaction structure 260. As shown in FIG. 14-20, reaction structure 260 can define various pixel positions A1-L3 that map to and are associated to and aligned with corresponding pixel positions A1-F4 defined by pixels 201 of the described pixel array as depicted in FIG. 2. That is, the same pixel position of a given alphanumeric number of a reaction structure 260 can be aligned to and associated to a pixel of the depicted pixel array of FIG. 2 having pixel position of the same alphanumeric number.

In the example of FIG. 14, first and second reaction sites 206 at adjacent pixel positions can have common relative orientations. Referring to FIG. 14 at pixel position E2, first reaction site 206 at A for selectively transmitting light rays of a first polarity can have a first orientation with respect to reaction site 206 at B for selectively transmitting excitation light of a second polarity. Similarly, at pixel position F2, first reaction site 206 at A for selectively transmitting light rays of a first polarity can have the first orientation with respect to reaction site 206 at B for selectively transmitting excitation light of a second polarity. At each of pixel position E2 and F2, the depth wise vertically extending aperture at B can have a longitudinally extending center axis 2074 that extends through aperture 207 defining reaction site 206 at A.

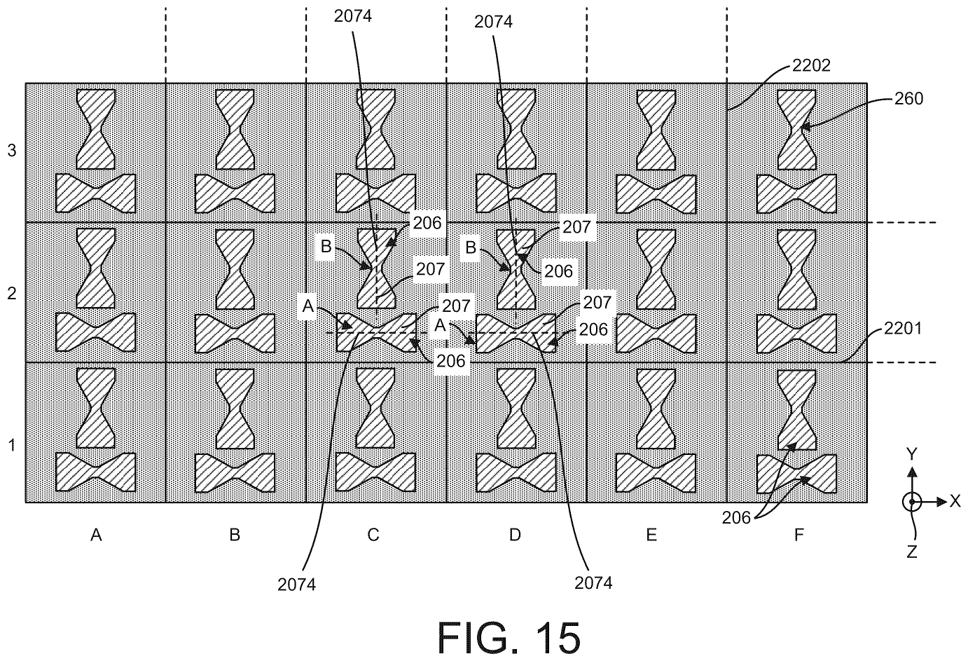

Referring to FIG. 15, an arrangement similar to the arrangement shown in FIG. 14 is depicted except in that reaction sites 206 defined by apertures 207 feature an hourglass shape from a top view rather than a rectangular shape from a top view. Referring to FIG. 15 at pixel position E2, first reaction site 206 at A for selectively transmitting light rays of a first polarity can have a first orientation with respect to reaction site 206 at B for selectively transmitting excitation light of a second polarity. Similarly, at pixel position F2, first reaction site 206 at A for selectively transmitting light rays of a first polarity can have the first orientation with respect to reaction site 206 at B for selectively transmitting excitation light of a second polarity. At each of pixel positions E2 and F2, the depth wise vertically extending aperture at B can have a longitudinally extending center axis 2074 that extends through aperture 207 defining reaction site 206 at A.

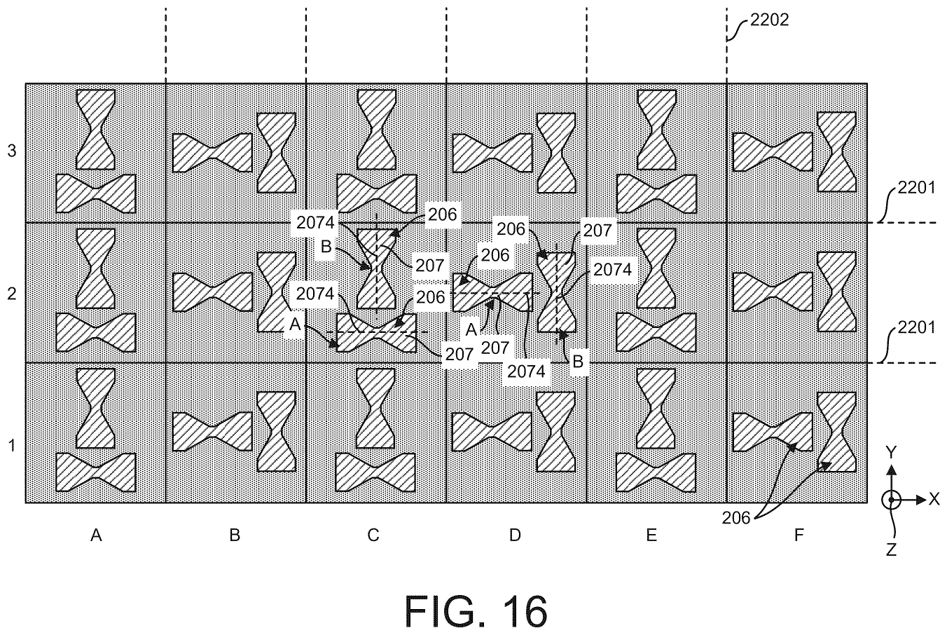

In the example of FIG. 16, reaction sites 206 at adjacent pixel positions can feature alternating relative orientations. Referring to pixel position C2, a longitudinally extending center axis 2074 of reaction site 206 at B for selectively transmitting polarized light excitation light of a second polarity can extend through aperture 207 of reaction site 206 for selectively transmitting polarized excitation light of a first polarity. However, the first and second reaction sites at A and B for an adjacent pixel position adjacent to pixel position C2 can have a second relative orientation different from the described first orientation. At adjacent pixel position D2, a longitudinally extending center axis 2074 of reaction site 206 at A for selectively transmitting polarized light rays of excitation light 101 of a first polarity can extend through aperture 207 of second reaction site 206 at B for selectively transmitting light rays of excitation light 101 of the second polarity.

The reaction sites 206 at pixel positions A1, C1, E1, A2, C2, E2, A3, C3, and E3 can feature the same relative orientation as described in reference to pixel position C2. The reaction sites 206 at pixel positions B1, D1, F1, B2, D2, F2, B3, D3, and F3 can feature the same relative orientation as depicted for pixel position D2. In the example of FIG. 16, the reaction sites 206 at pixel position C3 can be in common with the relative orientation of reaction sites 206 at adjacent pixels C1 and C3 but can be differentiated with respect to the relative orientation of reaction sites 206 featured in adjacent pixel positions B2 and D2.

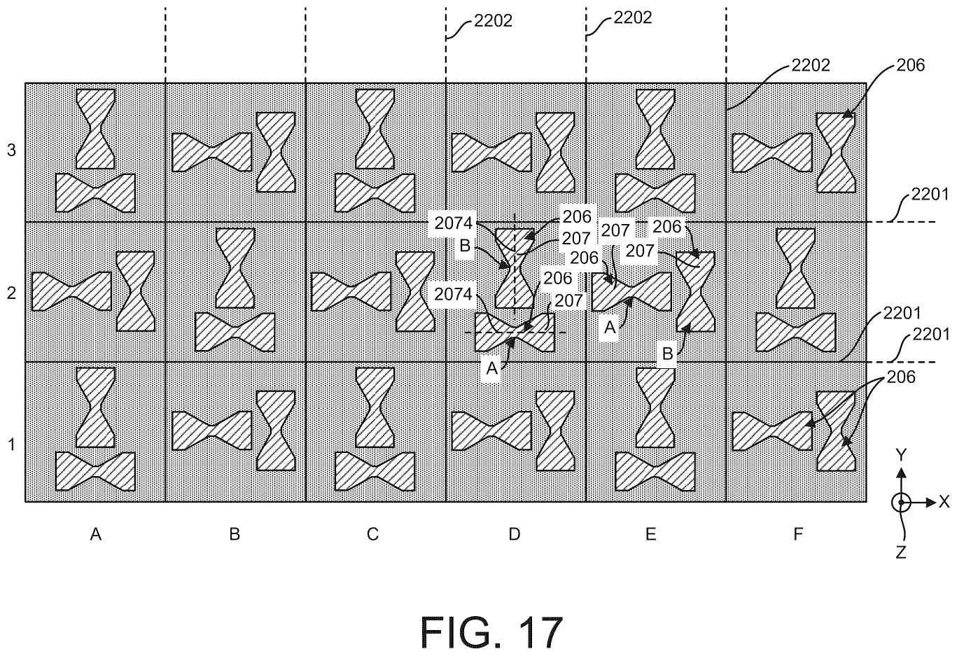

Referring to the example of FIG. 17, the reaction sites 206 at pixel position D2 and E2, respectively, can be as described in connection with pixel positions C2 and D2, respectively, in FIG. 16. In the example of FIG. 17, the pixel positions A1, C1, E1, B2, D2, F2, A3, C3, and E3 can have common relative orientations, i.e., in common with the relative orientation between reaction sites 206 described with reference to pixel position D2. The reaction sites 206 at pixel positions B1, D1, F1, A2, C2, E2, B3, D3, and F3 can have common relative orientations and can be in common with the relative orientation of reaction sites described in reference to pixel position E2 of FIG. 17. In the example of FIG. 17, the relative orientation between the reaction sites 206 at pixel position D2 can be differentiated with respect to the relative orientation between reaction sites 206 at each pixel position that is adjacent to pixel position D2, namely pixel positions D1, C2, C4, and D3.

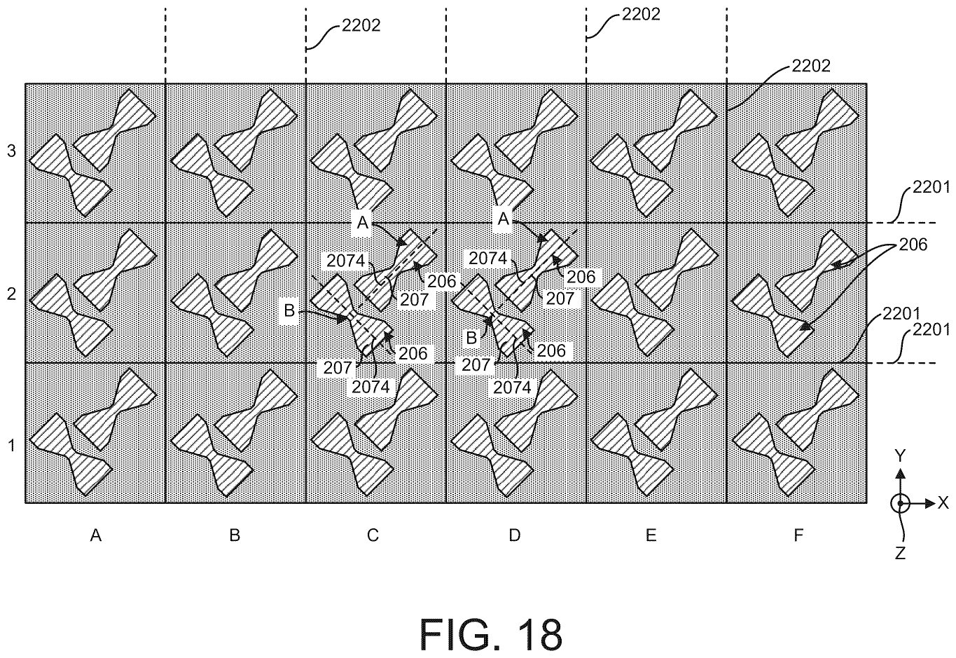

In the example of FIG. 18, the first and second reaction sites 206 at each pixel position have a common relative orientation (in respect to one another). At each pixel position, longitudinally extending center axis 2074 of aperture 207 for second reaction site 206 at B for selectively attenuating light rays of excitation light 101 of a second polarity can extend through aperture 207 for a first reaction site 206 at A for selectively transmitting light rays of excitation light 101 of a first polarity.

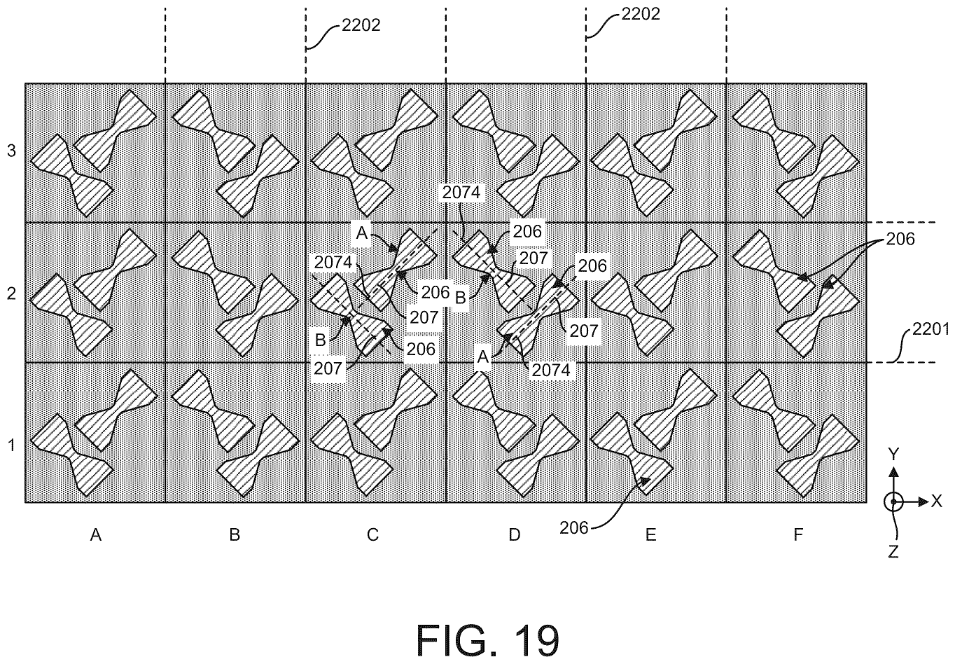

In the example of FIG. 19, reaction sites 206 at adjacent pixel positions can feature alternating relative orientations. Referring to pixel position C2, a longitudinally extending center axis 2074 of reaction site 206 at A for selectively transmitting polarized light excitation light of a first polarity can extend through aperture 207 of reaction site 206 at B for selectively transmitting polarized excitation light of a second polarity. However, the first and second reaction 206 sites at A and B for an adjacent pixel position adjacent to pixel position C2 can have a second relative orientation different from the described first orientation. At adjacent pixel position D2, a longitudinally extending center axis 2074 of reaction site 206 at B for selectively transmitting polarized light rays of excitation light 101 of a second polarity can extend through aperture 207 of first reaction site 206 at A for selectively transmitting light rays of excitation light 101 of the first polarity.

The reaction sites 206 at pixel positions A1, C1, E1, A2, C2, E2, A3, C3, and E3 can feature the same relative orientation as described in reference to pixel position C2. The reaction sites 206 at pixel positions B1, D1, F1, B2, D2, F2, B3, D3, and F3 can feature the same relative orientation as depicted for pixel position D2. In the example of FIG. 19, the relative orientations of reaction sites 206 at pixel position C2 can be in common with the relative orientation of reaction sites 206 at adjacent pixels C1 and C3 but can be differentiated with respect to the relative orientation of reaction sites 206 featured in adjacent pixel positions B2 and D2.

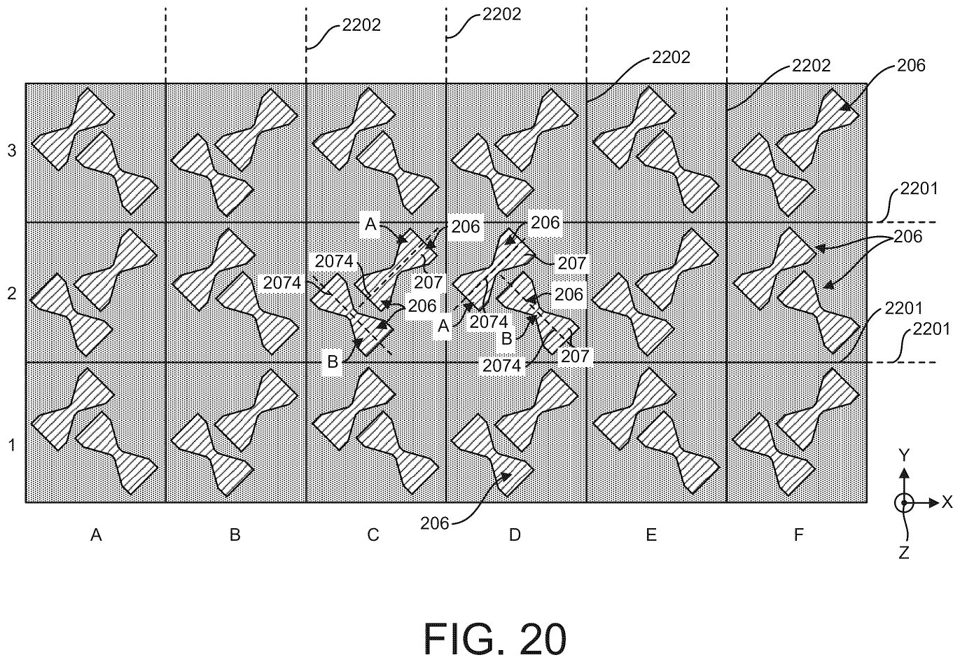

Referring to the example of FIG. 20, the reaction sites 206 at pixel position C2 and D2, respectively, can be as described in connection with pixel positions C2 and D2, respectively, in FIG. 19. In the example of FIG. 20, the pixel positions A1, C1, E1, B2, D2, F2, A3, C3, and E3 can have common relative orientations, i.e., in common with the relative orientation between reaction sites 206 described with reference to pixel position D2. The reaction sites 206 at pixel positions B1, D1, F1, A2, C2, E2, B3, D3, and F3 can have common relative orientations and can be in common with the relative orientation of reaction sites described in reference to pixel position D2 of FIG. 20. In the example of FIG. 20, the relative orientation between the reaction sites 206 at pixel position D2 can be differentiated with respect to the relative orientation between reaction sites 206 at each pixel position that is adjacent to pixel position D2, namely pixel positions D1, C2, C4, and D3.

As described in reference to FIGS. 16-20, wherein each pixel position is associated to a certain pixel and pixel sensor, adjacent pixel positions can have associated thereto respective first and second reaction sites, and the orientation between the first and second reaction sites can be differentiated between the adjacent. The first and second reaction sites 206 at a first pixel position can have a first relative orientation, and the first and second reaction sites 206 at a second pixel position adjacent to the first pixel position can have a second relative orientation. The varying orientations between adjacent pixel positions of the apparatus can increase a spacing distance between reaction sites of adjacent pixel positions in the absence of the varying orientations. With reference to FIGS. 16-20, it is seen that second to Nth pixels of the plurality of pixels at second to Nth pixel positions can have associated first and second reaction sites that are respectively configured according to a first reaction site and a second reaction site associated to a first pixel at a first pixel position, wherein the first and second reaction sites associated to adjacent pixels of the plurality of pixels have first and second different relative orientations, the first and second different relative orientations increasing a spacing distance between reaction sites of adjacent pixel positions relative to a spacing distance between reaction sites from adjacent pixel positions in the absence of the first and second different relative orientations.

In certain examples, modulating the signal of two different adjacent clusters C1, C2 in first and second separate nanowells 208 by use of polarization-based multiplexing and signal selection may add up to a two times or more increase in information density for a CMOS sensor, providing a benefit over CMOS-based detection devices with one cluster/well per pixel. In addition, increasing the information density on a CMOS-based flow cell may have the benefit of reducing the cost per gigabyte of sequencing information by the factor proportional to the increase in density. The practical impact of such innovation enables CMOS-based sequencing to achieve performance results at or exceeding results associated to larger platforms in terms of information density. Further, implementing the methods and structures disclosed herein may only require software changes coupled with CMOS fabrication modifications, leaving the instrument and reagent consumables substantially, if not fully untouched.

In reference again to FIG. 1, apparatus 100 can include processing circuitry 310. Processing circuitry 310 can include, according to one example, one or more processors 3101, memory 3102, and one or more input/output interface 3103. One or more processors 3101, memory 3102 and one or more input/output interface can be connected via system bus 3104. Memory 3102 can include a combination of system memory and storage memory. Memory 3102, according to one example, can store one or more programs for facilitating processes that are set forth herein. One or more processors 3101 can run one or more programs stored in memory 3102 to facilitate processes as is set forth herein. Memory 3102 can define a computer readable medium.

A DNA sequencing process facilitated by light energy exciter 10 is described with reference to FIGS. 1 and 4. Referring to FIG. 4, there is shown a spectral profile coordination diagram illustrating aspects of the operation of apparatus 100. According to one example, light energy exciter 10 can be configured to radiate excitation light at first and second different wavelengths and at first and second different polarities. As set forth herein, providing excitation light 101 at first and second different wavelength ranges facilitates dye chemistry DNA sequence reconstruction processes in which first and second dyes can be disposed in fluid within flow cell 282.

In the spectral profile coordination diagram of FIG. 4, spectral profile 1101 shown as a green light spectral profile is the spectral profile of excitation light 101 as emitted by light energy exciter 10. Spectral profile 1501 is the spectral profile of the emission light 501 caused by the fluorescence of a fluorophore on being excited by excitation light 101. Spectral profile 1220 is the transmission profile (detection band) of pixel sensors 202, according to one example. It will be understood that the spectral profile coordination diagram of FIG. 4 is intended to represent general features common to some examples, but that variations of the indicated spectral profiles are common.

In one aspect, excitation light 101 can commonly include, in addition to a green light spectral profile, a blue light spectral profile (not shown) wherein apparatus 100 is switchable between modes in which (a) the green light spectral profile is active with the blue light spectral profile being inactive, and (b) the blue light spectral profile is active with the green light spectral profile being inactive. In other examples, there can be different combinations of excitation light 101 and emission light 501. In one example, the spectral profile 1101 of excitation light 101 can feature a center wavelength in the blue light wavelength range and the spectral profile of emission light 501 can feature a center wavelength in the green wavelength range.

Examples herein recognize in reference to the spectral profile coordination diagram of FIG. 4 that processing circuitry 310 can be configured to (a) determine that the first fluorophore is attached to a respective cluster C1, C2 based on fluorescence being sensed by a pixel sensor 202 under excitation restricted to excitation by one or more green emitting light sources and fluorescence not being sensed by the pixel sensor 202 under excitation restricted to excitation by one or more blue emitting light source; (b) determine that the second fluorophore is attached to a cluster C1, C2 based on fluorescence being sensed by a pixel sensor 202 under excitation restricted to excitation by one or more blue emitting light sources and fluorescence not being sensed by the pixel sensor 202 under excitation restricted to excitation by one or more green emitting light sources; and (c) determine that the third fluorophore is attached to a cluster C1, C2 based on fluorescence being sensed by a pixel sensor 202 under excitation restricted to excitation by one or more green emitting light sources and fluorescence also being sensed by the pixel sensor 202 under excitation restricted to excitation by one or more blue emitting light sources.

In another aspect, processing circuitry 310 can be configured to, in effect, switch on and off first reaction sites 206 at A and second reaction sites at B, at respective pixel positions of reaction structure 260. The first reaction sites 206 at A can be switched on by radiating light rays of excitation light 101 of a first polarity. The second reaction sites 206 at B can be switched on by radiating light rays of excitation light 101 of a second polarity.

Processing circuitry 310 can discriminate which fluorophores have attached to clusters, and can determine nucleotide types, e.g., A, C, T, and G that are present in a fragment of a DNA strand which can define a cluster C1, C2, e.g., using a decision logic data structure indicated by the calling chart as set forth herein.

Processing circuitry 310 can run a process in support of DNA sequence reconstruction in a plurality of cycles. In each cycle, a different portion of a DNA fragment can be subject to sequencing processing to determine a nucleotide type, e.g., A, C, T, or G, associated to the fragment, e.g., using a decision data structure such as a decision data structure as set forth in Table A and Table B.

TABLE A

| Detected | Detected | | |
|---|---|---|---|
| fluorescence | fluorescence | | |
| under excitation | under excitation | | |
| restricted to | restricted to | | |
| excitation of first | excitation of first | | |
| polarity by one or | polarity by one or | | |
| more green | more blue | Fluorophore | |
| emitting light | emitting light | presence | Nucleotide |
| sources | sources | indicated | indicated |
| YES | NO | first Fluorophore | Nucleotide1 |
| NO | YES | second Fluorophore | Nucleotide2 |
| YES | YES | third Fluorophore | Nucleotide3 |
| NO | NO | — | Nucleotide4 |

TABLE B

| Detected | Detected | | |
|---|---|---|---|
| fluorescence | fluorescence | | |
| under excitation | under excitation | | |
| restricted to | restricted to | | |
| excitation of | excitation of | | |
| second polarity | second polarity | | |
| by one or more | by one or more | Fluorophore | |
| green emitting | blue emitting | presence | Nucleotide |
| light sources | light sources | indicated | indicated |
| YES | NO | first Fluorophore | Nucleotide1 |
| NO | YES | second Fluorophore | Nucleotide2 |
| YES | YES | third Fluorophore | Nucleotide3 |
| NO | NO | — | Nucleotide4 |

Referring to Tables A and B, reaction sites 206 at A associated to pixels 201 can be activated and turned on under excitation by light rays of a first polarity (Table A), and reaction sites 206 at B associated to pixels 201 can be activated and turned on under excitation by light rays of a second polarity (Table B).

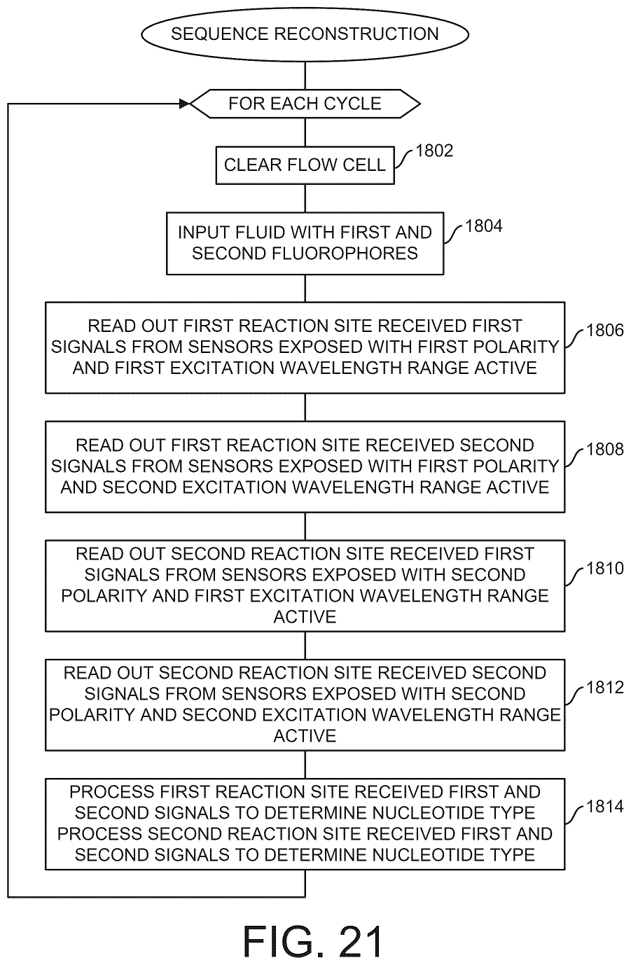

Aspects of a process which can be run by processing circuitry 310 for use in performing DNA sequence reconstruction using light energy exciter 10 is described in the flowchart of FIG. 21.

At block 1802, processing circuitry 310 can clear flow cell 282, meaning processing circuitry 310 can remove fluid from flow cell 282 used during a prior cycle. At block 1804, processing circuitry 310 can input into flow cell 282 fluid having multiple fluorophores, e.g., first and second fluorophores, or first, second, and third fluorophores.

At block 1806, processing circuitry 310 can read out first reaction site received first signals from pixel sensors 202 exposed with a first polarity and first wavelength range of excitation light 101 active. The first reaction sites 206 at A throughout the views can be selectively transmitting under illumination by excitation light of a first polarity. At block 1806, processing circuitry 310 can control light energy exciter 10 so that during an exposure period of pixel sensors 202, light energy exciter 10 emits excitation light 101 restricted to excitation by one or more green light sources of light energy exciter 10. At block 1806, processing circuitry 310 can, during an exposure period of pixel sensors 202, energize each one or more green emitting light source of light energy exciter 10. With light energy exciter 10 being controlled as described so that green light sources are on and blue light sources are off during an exposure period of pixel sensors 202, processing circuitry 310 at block 1806 can read out first signals from pixel sensors 202 exposed with excitation restricted to excitation by one or more green light sources as set forth herein, including with reference to the spectral profile coordination diagram of FIG. 4.

At block 1808, processing circuitry 310 can read out first reaction site received second signals from pixel sensors 202 exposed with second polarity and a second wavelength range excitation active. The first reaction sites 206 at A throughout the views can be selectively transmitting under illumination by excitation light of a first polarity. At block 1808, processing circuitry 310 can control light energy exciter 10 so that during an exposure period of pixel sensors 202, light energy exciter 10 emits excitation light restricted to excitation by one or more blue light sources of light energy exciter 10. At block 1808, processing circuitry 310 can, during an exposure period of pixel sensors 202, energize each of one or more blue emitting light sources of light energy exciter 10 while maintaining in a deenergized state each one or more green emitting light sources of light energy exciter 10. With light energy exciter 10 being controlled as described so that blue light sources are on and green light sources are off during an exposure period of pixel sensors 202, processing circuitry 310 at block 1808 can read out second signals from pixel sensors 202 exposed with excitation restricted to excitation by one or more blue light sources of light energy exciter 10 as set forth herein.

At block 1810, processing circuitry 310 can read out second reaction site received first signals from pixel sensors 202 exposed with a first polarity and first wavelength range of excitation light 101 active. The second reaction sites 206 at B throughout the views can be selectively transmitting under illumination by excitation light of a second polarity. At block 1810, processing circuitry 310 can control light energy exciter 10 so that during an exposure period of pixel sensors 202, light energy exciter 10 emits excitation light 101 restricted to excitation by one or more green light sources of light energy exciter 10. At block 1810, processing circuitry 310 can, during an exposure period of pixel sensors 202, energize each one or more green emitting light source of light energy exciter 10. With light energy exciter 10 being controlled as described so that green light sources are on and blue light sources are off during an exposure period of pixel sensors 202, processing circuitry 310 at block 1810 can read out first signals from pixel sensors 202 exposed with excitation restricted to excitation by one or more green light sources as set forth herein, including with reference to the spectral profile coordination diagram of FIG. 4.

At block 1812, processing circuitry 310 can read out second reaction site received second signals from pixel sensors 202 exposed with second polarity and a second wavelength range excitation active. The second reaction sites 206 at B throughout the views can be selectively transmitting under illumination by excitation light of a second polarity. At block 1812, processing circuitry 310 can control light energy exciter 10 so that during an exposure period of pixel sensors 202, light energy exciter 10 emits excitation light restricted to excitation by one or more blue light sources of light energy exciter 10. At block 1812, processing circuitry 310 can, during an exposure period of pixel sensors 202, energize each of one or more blue emitting light sources of light energy exciter 10 while maintaining in a deenergized state each one or more green emitting light sources of light energy exciter 10. With light energy exciter 10 being controlled as described so that blue light sources are on and green light sources are off during an exposure period of pixel sensors 202, processing circuitry 310 at block 1812 can read out second signals from pixel sensors 202 exposed with excitation restricted to excitation by one or more blue light sources of light energy exciter 10 as set forth herein.

At each of block 1806, block 1808, block 1810, and block 1812, light energy exciter 10 can be directing excitation light 101 in the referenced narrow band (green light in block 1806 and blue light at block 1808) to all reaction sites 206 of reaction structure 260 simultaneously so that all clusters C1, C2, supported by reaction structure 260, including clusters C1 and C2 disposed in adjacent reaction sites 206 that are commonly associated to a certain one pixel 201, are simultaneously excited with the narrow band excitation light 101 described with reference to block 1806, block 1808, block 1810, and block 1812. Accordingly, examples herein recognize that apparatus 100 can facilitate sequencing without precision directional control of excitation light. In other examples, excitation can advantageously be performed with use of precision directional control of excitation light 101 so that a first reaction site 206 associated to a certain pixel of pixel sensors 202 is excited without exciting a second reaction site associated to the certain pixel of pixel sensors 202.

At block 1814, processing circuitry 310 for the current cycle can process the first signals read out at block 1806 and the second signals read out at block 1808 to determine a nucleotide type of the DNA fragment being subject to testing during the current cycle, e.g., using a decision data structure as set forth in Table A and Table B, according to one example. Processing circuitry 310 can perform the described nucleotide identification process described with reference to the flowchart of FIG. 21 for each cycle of the DNA sequencing process until nucleotide identification is performed for each scheduled cycle.

Accordingly, there is set forth herein according to one example, detecting, using a pixel sensor of a plurality of pixels sensors, a read signal, the read signal being dependent on a first cluster signal emitted from a first reaction site associated to the pixel sensor under illumination by excitation light of a first polarity; detecting, using a pixel sensor of a plurality of pixels sensors, a second read signal, the second read signal being dependent on a second cluster signal emitted from a second reaction site associated to the pixel sensor under illumination by excitation light of a second polarity; determining an identity of a first analyte of interest in the first reaction site in dependence on the read signal detected using the pixel sensor; and determining an identity of a second analyte of interest in the second reaction site in dependence on the second read signal detected using the pixel sensor.

Accordingly, there is set forth herein according to one example a method comprising illuminating a first reaction site and a second reaction site by excitation light of a first polarity, the first reaction site and second reaction site associated to a pixel of a plurality of pixels, detecting, using a pixel sensor of the pixel, a first read signal; illuminating the first reaction site and the second reaction site by excitation light of a second polarity; detecting, using the pixel sensor of the pixel, a second read signal; determining an identity of a first analyte of interest in the first reaction site in dependence on the first read signal detected using the pixel sensor; and determining an identity of a second analyte of interest in the second reaction site in dependence on the second read signal detected using the pixel sensor. There is also set forth herein, the method wherein the first reaction site and second reaction site are simultaneously illuminated by excitation light of a first polarity. There is also set forth herein, the method wherein the first reaction site and second reaction site are simultaneously illuminated by excitation light of a second polarity. There is also set forth herein, the method wherein the first reaction site and second reaction site are illuminated by excitation light of a first polarity during a first time period, wherein the first reaction site and second reaction site are illuminated by excitation light of a second polarity during a second time period, where the first time period is different than the second time period.

In examples set forth herein, different reaction sites 206 can include and be defined by different nanowells. In other examples, reaction sites can be defined by alternative features which can be defined by reaction structure 260. The alternative features, in some examples, can be disposed to be aligned with and below an aperture 207 of a reaction site 206. The alternative features can comprise, e.g., structural feature variations and/or variations in chemical composition. Structural features defining structural feature variations can form an array in or on reaction structure 260. Exemplary structural features can include, but are not limited to, nanowells as set forth herein, posts, pads, ridges, channels, and/or layers of a multilayer material. A feature can have characteristics such as size (e.g., volume, diameter, and depth), shape (e.g., round, elliptical, triangular, square, polygonal, star shaped (having any suitable number of vertices), irregular, or having concentric features separated by a dielectric material), and distribution (e.g., spatial locations of the features within the dielectric material, e.g., regularly spaced or periodic locations, or irregularly spaced or aperiodic locations). The cross section of a feature can be, but need not necessarily be, uniform along the length of the feature.

Examples herein recognize that challenges exist to decreasing pixel pitch below 0.7 um. Examples herein can increase density without reducing pixel size by configuring a pixel array, e.g., CMOS pixel array in such a way that multiple clusters can be detected per pixel. Examples herein recognize that since each pixel has only one pixel sensor which measures the number of photons incident on the pixel sensor, distinguishing the signal coming from multiple clusters is not possible by simply adding more than one cluster to a pixel.

Examples herein can provide a method to distinguish the signal generated from different clusters disposed on a single pixel. The clusters can be disposed at a single pixel position defined by the single pixel. Examples herein provide a method to selectively illuminate with light rays of excitation light 101 one cluster at a time, e.g., first clusters C1 (FIG. 1) at first reaction sites 206 (at A) of reaction structure 260 can be illuminated with light rays of excitation light 101 at a first time, and second clusters (C2) at second reaction sites (at B) of reaction structure 260 can be illuminated with light rays of excitation light 101 at a second time. To selectively shine light into a cluster examples herein can use excitation light having first and second orthogonal polarizations and can configure first and second reaction sites 206 in a way that each reaction site 206 selectively transmits light with a certain polarization, i.e., the first polarization, or alternatively, the second polarization. Examples herein recognize that increasing the information density on a fixed, e.g., CMOS-based flow cell can provide the benefit reducing the cost per gigabyte of sequencing information by the factor proportional to the increase in density.

Example herein can achieve 2× increase in information density associated to a pixel array without shrinking pixel size. Examples herein, by increasing the information density on a fixed, e.g., CMOS-based flow cell can provide the benefit of reducing the cost per gigabyte of sequencing information by a factor proportional to the increase in density.

A small sample of combinations expressed herein include the following: A1. An apparatus comprising: a first reaction site and a second reaction site associated to a common pixel, wherein the pixel comprises a pixel sensor. A2. The apparatus of A1, wherein the first reaction site includes first nanowell, and the second reaction site includes a second nanowell. A3. The apparatus of A1 or A2, wherein the first reaction site selectively transmits excitation light of a first polarity. A4. The apparatus of any one of A1 through A3, wherein the first reaction site selectively transmits excitation light of a first polarity, and wherein the second reaction site selectively transmits excitation light of a second polarity. A5. The apparatus of any one of A1 through A4, wherein the first reaction site selectively blocks excitation light of a second polarity. A6. The apparatus of any one of A1 through A5, wherein the first reaction site selectively blocks excitation light of a second polarity, and wherein the second reaction site selectively blocks excitation light of a first polarity. A7. The apparatus of any one of A1 through A6, wherein the first reaction site selectively transmits excitation light of a first polarity, and wherein the second reaction site selectively transmits excitation light of a second polarity, wherein the first reaction site selectively blocks excitation light of the second polarity, and wherein the second reaction site selectively blocks excitation light of the first polarity. A8. The apparatus of any one of A1 through A7, wherein the first reaction site and the second reaction site are configured so that under illumination by excitation light of a first polarity, the first reaction site and the second reaction site exhibit a photonic power transmission ratio in favor of the first reaction site. A9. The apparatus of any one of A1 through A8, wherein the first reaction site and the second reaction site are configured so that under illumination by excitation light of a second polarity, the second reaction site and the first reaction site exhibit a photonic power transmission ratio in favor of the second reaction site. A10. The apparatus of any one of A1 through A9, wherein the first reaction site and the second reaction site are configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site. A11. The apparatus of any one of A1 through A10, wherein the first reaction site and the second reaction site include respective first and second elongated apertures configured so that under illumination by excitation light of a first polarity, the first reaction site selectively transmits excitation light rays of the first polarity and the second reaction site selectively blocks excitation light rays of the first polarity, and further so that under illumination by excitation light of a second polarity, the second reaction site selectively transmits excitation light rays of second polarity and the first reaction site selectively blocks excitation light rays of the second polarity. A12. The apparatus of any one of A1 through A11, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site. A13. The apparatus of any one of A1 through A12, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture extending in a first orientation, the second elongated aperture extending in a second orientation. A14. The apparatus of any one of A1 through A13, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation. A15. The apparatus of any one of A1 through A14, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation, wherein the second orientation is orthogonal to the first orientation. A16. The apparatus of any one of A1 through A15, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system. A17. The apparatus of any one of A1 through A16, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system, wherein the Y-axis is orthogonal to the X-axis. A18. The apparatus of any one of A1 through A17, wherein the first reaction site and the second reaction site include a rectangular aperture. A19. The apparatus of any one of A1 through A17, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation, the second elongated aperture being rectangular shaped and having a longitudinally extending center axis extending in a second orientation. A20. The apparatus of any one of A1 through A17, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation in parallel with an X-axis of a reference coordinate system, the second elongated aperture being rectangular shaped and having a longitudinally extending center axis extending in a second orientation in parallel with an Y-axis of the reference coordinate system, wherein the Y-axis is orthogonal to the X-axis. A21. The apparatus of any one of A1 through A17, wherein the first reaction site and the second reaction site include an hourglass aperture. A22. The apparatus of any one of A1 through A17, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation, the second elongated aperture being hourglass shaped and having a longitudinally extending center axis extending in a second orientation. A23. The apparatus of any one of A1 through A17, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation in parallel with an X-axis of a reference coordinate system, the second elongated aperture being hourglass shaped and having a longitudinally extending center axis extending in a second orientation in parallel with an Y-axis of the reference coordinate system, wherein the Y-axis is orthogonal to the X-axis. B1. An apparatus comprising: a plurality of pixels; a first reaction site associated to a pixel of the plurality of pixels; a second reaction site associated to the pixel; wherein the first reaction site is configured to selectively transmit light of a first polarity; and wherein the second reaction site is configured to selectively transmit light of a second polarity. B2. The apparatus of B1, wherein the first reaction site includes a first nanowell, and the second reaction site includes a second nanowell. B3. The apparatus of B1 or B2 wherein the first reaction site is configured to selectively block excitation light of the second polarity. B4. The apparatus of any one of B1 through B3 wherein the second reaction site is configured to selectively block excitation light of the first polarity. B5. The apparatus of any one of B1 through B4, wherein the first reaction site is configured to selectively block excitation light of the second polarity, and the second reaction site is configured to selectively block excitation light of the first polarity. B6. The apparatus of any one of B1 through B5, wherein the first reaction site and the second reaction site are configured so that under illumination by excitation light of the first polarity, the first reaction site and the second reaction site exhibit a photonic power transmission ratio in favor of the first reaction site. B7. The apparatus of any one of B1 through B6, wherein the first reaction site and the second reaction site are configured so that under illumination by excitation light of the second polarity, the second reaction site and the first reaction site exhibit a photonic power transmission ratio in favor of the second reaction site. B8. The apparatus of any one of B1 through B7, wherein the first reaction site and the second reaction site are configured so that under illumination by excitation light of the first polarity, the first reaction site and the second reaction site exhibit a photonic power transmission ratio in favor of the first reaction site, and further so that under illumination by excitation light of the second polarity, the second reaction site and the first reaction site exhibit a photonic power transmission ratio in favor of the second reaction site. B9. The apparatus of any one of B1 through B8 wherein the first reaction site and the second reaction site include respective first and second elongated apertures configured so that under illumination by excitation light of the first polarity, the first reaction site selectively transmits excitation light rays of the first polarity and the second reaction site selectively blocks excitation light rays of the first polarity, and further so that under illumination by excitation light of the second polarity, the second reaction site selectively transmits excitation light rays of the second polarity and the first reaction site selectively blocks excitation light rays of the second polarity. B10. The apparatus of any one of B1 through B9, wherein the first reaction site is configured to selectively transmit the light of the first polarity to a cluster location of the first reaction site; and wherein the second reaction site is configured to selectively transmit the light of the second polarity to a cluster location of the second reaction site. B11. The apparatus of any one of B1 through B10, wherein the first reaction site and the second reaction site include respective first and second elongated apertures configured so that under illumination by excitation light of the first polarity, the first reaction site selectively transmits excitation light rays of the first polarity to a cluster location of the first reaction site, and the second reaction site selectively blocks excitation light rays of the first polarity, and further so that under illumination by excitation light of the second polarity, the second reaction site selectively transmits excitation light rays of the second polarity to a cluster location of the second reaction site and the first reaction site selectively blocks excitation light rays of the second polarity. B12. The apparatus of any one of B1 through B11, wherein the first reaction site and the second reaction site include respective first and second elongated apertures configured so that under illumination by excitation light of the first polarity, the first reaction site selectively transmits excitation light rays of the first polarity to a cluster location of the first reaction site, and the second reaction site selectively blocks excitation light rays of the first polarity, and further so that under illumination by excitation light of the second polarity, the second reaction site selectively transmits excitation light rays of the second polarity to a cluster location of the second reaction site and the first reaction site selectively blocks excitation light rays of the second polarity, wherein the first reaction site includes a first nanowell and wherein the second reaction site includes a second nanowell, and wherein the apparatus includes a metal aperture defining layer extending over the first nanowell and the second nanowell, wherein the metal aperture defining layer has formed therein the first elongated aperture and the second elongated aperture, wherein the first elongated aperture is aligned with the first nanowell, and wherein the second elongated aperture is aligned with the second nanowell. B13. The apparatus of any one of B1 through B12, wherein the first reaction site and the second reaction site include respective first and second elongated apertures configured so that under illumination by excitation light of the first polarity, the first reaction site selectively transmits excitation light rays of the first polarity to a cluster location at a cluster location elevation of the first reaction site, and the second reaction site selectively blocks excitation light rays of the first polarity, and further so that under illumination by excitation light of the second polarity, the second reaction site selectively transmits excitation light rays of the second polarity to a cluster location at a cluster location elevation of the second reaction site and the first reaction site selectively blocks excitation light rays of the second polarity, wherein the first reaction site includes a first nanowell and wherein the second reaction site includes a second nanowell, and wherein the apparatus includes a metal aperture defining layer extending over the first nanowell and the second nanowell, wherein the metal aperture defining layer has formed therein the first elongated aperture and the second elongated aperture, wherein the first elongated aperture is aligned with the first nanowell, and wherein the second elongated aperture is aligned with the second nanowell, wherein the cluster location elevation of the first reaction site is delimited by a first elevation and a second elevation, wherein the first elevation is defined by a bottom surface of the first nanowell, and the second elevation is defined by a bottom surface of the metal aperture defining layer. B14. The apparatus of any one of B1 through B13, wherein the first reaction site and the second reaction site include a rectangular aperture. B15. The apparatus of any one of B1 through B14, wherein the first reaction site and the second reaction site include an hourglass aperture. C1. An apparatus comprising: a plurality of pixels; a first reaction site associated to a pixel of the plurality of pixels; a second reaction site associated to the pixel; wherein the first reaction site and the second reaction site are configured so that under illumination by excitation light of a first polarity, the first reaction site and the second reaction site exhibit a photonic power transmission ratio in favor of the first reaction site. C2. The apparatus of C1, wherein the first reaction site includes a first nanowell and wherein the second reaction site includes a second nanowell. C3. The apparatus of C1 or C2, wherein the first reaction site and the second reaction site are configured so that under illumination by excitation light of a second polarity, the second reaction site and the first reaction site exhibit a photonic power transmission ratio in favor of the second reaction site. C4. The apparatus of any one of C1 through C4, wherein the first reaction site and the second reaction site are configured so that under illumination by excitation light of a second polarity, the second reaction site and the first reaction site exhibit a photonic power transmission ratio in favor of the second reaction site, wherein the photonic power transmission ratio in favor of the first reaction site is at least about 2:1 wherein the photonic power transmission ratio in favor of the second reaction site is at least about 2:1. C5. The apparatus of any one of C1 through C4, wherein the first reaction site and the second reaction site are configured so that under illumination by excitation light of a second polarity, the second reaction site and the first reaction site exhibit a photonic power transmission ratio in favor of the second reaction site, wherein the photonic power transmission ratio in favor of the first reaction site is at least about 5:1 wherein the photonic power transmission ratio in favor of the second reaction site is at least about 5:1. C6. The apparatus of any one of C1 through C5, wherein the first reaction site and the second reaction site are configured so that under illumination by excitation light of a second polarity, the second reaction site and the first reaction site exhibit a photonic power transmission ratio in favor of the second reaction site, wherein the photonic power transmission ratio in favor of the first reaction site is at least about 10:1 wherein the photonic power transmission ratio in favor of the second reaction site is at least about 10:1. C7. The apparatus of any one of C1 through C6, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture extending in a first orientation, the second elongated aperture extending in a second orientation. C8. The apparatus of C7, wherein the first elongated aperture and the second elongated aperture each have a thickness of at least about 150 nm. C9. The apparatus of C7, wherein the first elongated aperture and the second elongated aperture each have a thickness of at least about 200 nm. C10. The apparatus of C7, wherein the first elongated aperture and the second elongated aperture each have a thickness of about 250 nm or less. C11. The apparatus of any one of C1 through C10, wherein the first reaction site is configured so that under illumination by excitation light of the first polarity, the first reaction site selectively transmits excitation light rays of the first polarity to a cluster location of the first reaction site. C12. The apparatus of any one of C1 through C11, wherein the first reaction site is configured so that under illumination by excitation light of the first polarity, the first reaction site selectively transmits excitation light rays of the first polarity to a cluster location at a cluster location elevation of the first reaction site, wherein the first reaction site includes a nanowell and a metal aperture defining layer, wherein the cluster location elevation is delimited by a first elevation and a second elevation, the first elevation being defined by a bottom surface of the nanowell, and wherein the second elevation is defined by a bottom surface of the metal aperture defining layer. C13. The apparatus of any one of C1 through C11, wherein second to Nth pixels of the plurality of pixels at second to Nth pixel positions have associated first and second reaction sites that are respectively configured according to the first reaction site and the second reaction site associated to the pixel, wherein the first and second reaction sites associated to adjacent pixels of the plurality of pixels have first and second different relative orientations, the first and second different relative orientations increasing a spacing distance between reaction sites at adjacent pixel positions relative to a spacing distance between reaction sites at adjacent pixel positions in the absence of the different relative orientations. C14. The apparatus of C13, wherein the second to Nth pixels are second to one millionth pixels. C15. The apparatus of any one of C1 through C14, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site. C16. The apparatus of any one of C1 through C15, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture extending in a first orientation, the second elongated aperture extending in a second orientation. C17. The apparatus of any one of C1 through C16, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation. C18. The apparatus of any one of C1 through C17, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation, wherein the second orientation is orthogonal to the first orientation. C19. The apparatus of any one of C1 through C18, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system. C20. The apparatus of any one of C1 through C19, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system, wherein the Y-axis is orthogonal to the X-axis. C21 The apparatus of any one of C1 through C20, wherein the first reaction site and the second reaction site include a rectangular aperture. C22. The apparatus of any one of C1 through C20, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation, the second elongated aperture being rectangular shaped and having a longitudinally extending center axis extending in a second orientation. C23. The apparatus of any one of C1 through C20, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation in parallel with an X-axis of a reference coordinate system, the second elongated aperture being rectangular shaped and having a longitudinally extending center axis extending in a second orientation in parallel with an Y-axis of the reference coordinate system, wherein the Y-axis is orthogonal to the X-axis. C24. The apparatus of any one of C1 through C20, wherein the first reaction site and the second reaction site include an hourglass aperture. C25. The apparatus of any one of C1 through C20, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation, the second elongated aperture being hourglass shaped and having a longitudinally extending center axis extending in a second orientation. C26. The apparatus of any one of C1 through C20, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation in parallel with an X-axis of a reference coordinate system, the second elongated aperture being hourglass shaped and having a longitudinally extending center axis extending in a second orientation in parallel with an Y-axis of the reference coordinate system, wherein the Y-axis is orthogonal to the X-axis. D1. A method comprising: detecting, using a pixel sensor of a plurality of pixels sensors, a read signal, the read signal being dependent on a first cluster signal emitted from a first reaction site associated to the pixel sensor under illumination by excitation light of a first polarity; detecting, using a pixel sensor of a plurality of pixels sensors, a second read signal, the second read signal being dependent on a second cluster signal emitted from a second reaction site associated to the pixel sensor under illumination by excitation light of a second polarity; determining an identity of a first analyte of interest in the first reaction site in dependence on the read signal detected using the pixel sensor; and determining an identity of a second analyte of interest in the second reaction site in dependence on the second read signal detected using the pixel sensor. D2. The method of D1, wherein the first reaction site includes a first nanowell, and the second reaction site includes a second nanowell. D3. The method of D1 or D2, wherein the second reaction site is configured to selectively block excitation light of the first polarity. D4. The method of any one of D1 through D3, wherein the first reaction site is configured to selectively block excitation light of the second polarity. D5. The method of any one of D1 through D4, wherein the first reaction site is configured to selectively transmit excitation light of the first polarity, and the second reaction site is configured to selectively transmit excitation light of the second polarity. D6. The method of any one of D1 through D5, wherein the first reaction site and the second reaction site are configured so that under illumination by excitation light of a first polarity, the first reaction site and the second reaction site exhibit a photonic power transmission ratio in favor of the first reaction site. D7. The method of any one of D1 through D6, wherein the first reaction site and the second reaction site are configured so that under illumination by excitation light of a second polarity, the second reaction site and the first reaction site exhibit a photonic power transmission ratio in favor of the second reaction site. D8. The method of any one of D1 through D7, wherein the first reaction site and the second reaction site are configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site. D9. The method of any one of D1 through D8, wherein the first reaction site and the second reaction site include a rectangular aperture. D10. The method of any one of D1 through D8, wherein the first reaction site and the second reaction site include an hourglass aperture. E1. A method comprising: illuminating a first reaction site and a second reaction site by excitation light of a first polarity, the first reaction site and second reaction site associated to a pixel of a plurality of pixels; detecting, using a pixel sensor of the pixel, a first read signal; illuminating the first reaction site and the second reaction site by excitation light of a second polarity; detecting, using the pixel sensor of the pixel, a second read signal; determining an identity of a first analyte of interest in the first reaction site in dependence on the first read signal detected using the pixel sensor; and determining an identity of a second analyte of interest in the second reaction site in dependence on the second read signal detected using the pixel sensor. E2. The method of E1 wherein the first reaction site and second reaction site are simultaneously illuminated by excitation light of a first polarity. E3. The method of E1 or E2, wherein the first reaction site and second reaction site are simultaneously illuminated by excitation light of a second polarity. E4. The method of any of E1 through E3, wherein the first reaction site and second reaction site are illuminated by excitation light of a first polarity during a first time period, wherein the first reaction site and second reaction site are illuminated by excitation light of a second polarity during a second time period, where the first time period is different than the second time period. E5. The method of E4, wherein the first reaction site is configured to selectively transmit excitation light of the first polarity, and the second reaction site is configured to selectively transmit excitation light of the second polarity. E6. The method of any of E1 through E5, wherein the first reaction site includes a first nanowell, and the second reaction site includes a second nanowell. E7. The method of any of E1 through E6, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site. E8. The method of any of E1 through E7, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture extending in a first orientation, the second elongated aperture extending in a second orientation. E9. The method of any of E1 through E8, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation. E10 The method of any of E1 through E9, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation, wherein the second orientation is orthogonal to the first orientation. E11. The method of any of E1 through E10, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system. E12. The method of any of E1 through E11, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system, wherein the Y-axis is orthogonal to the X-axis. E13. The method of any of E1 through E12, wherein the first reaction site and the second reaction site include a rectangular aperture. E14. The method of any of E1 through E13, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation, the second elongated aperture being rectangular shaped and having a longitudinally extending center axis extending in a second orientation. E15. The method of any of E1 through E13, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being rectangular shaped and having a longitudinally extending center axis extending in a first orientation in parallel with an X-axis of a reference coordinate system, the second elongated aperture being rectangular shaped and having a longitudinally extending center axis extending in a second orientation in parallel with an Y-axis of the reference coordinate system, wherein the Y-axis is orthogonal to the X-axis. E16. The method of any of E1 through E13, wherein the first reaction site and the second reaction site include an hourglass aperture. E17. The method of any of E1 through E13, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation, the second elongated aperture being hourglass shaped and having a longitudinally extending center axis extending in a second orientation. E18. The method of any of E1 through E13, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture being hourglass shaped and having a longitudinally extending center axis extending in a first orientation in parallel with an X-axis of a reference coordinate system, the second elongated aperture being hourglass shaped and having a longitudinally extending center axis extending in a second orientation in parallel with an Y-axis of the reference coordinate system, wherein the Y-axis is orthogonal to the X-axis.

The flowchart and block diagrams in the figures illustrate the architecture, functionality, and operation of possible implementations of systems, methods, and computer program products according to various examples of the present implementation. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, processes, operations, elements, and/or components, but do not preclude the presence or addition of one or more other features, integers, steps, processes, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more examples has been presented for purposes of illustration and description, but is not intended to be exhaustive or limited to in the form disclosed. Many modifications and variations will be apparent to those of ordinary skill in the art. Any example was chosen and described in order to best explain various aspects and the practical application, and to enable others of ordinary skill in the art to understand various examples with various modifications as are suited to the particular use contemplated.

It should be appreciated that all combinations of the foregoing concepts and additional concepts discussed in greater detail below (provided such concepts are not mutually inconsistent) are contemplated as being part of the subject matter disclosed herein at least to achieve the benefits as described herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely provided by way of example. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph (35 U.S.C. § 112(f)), unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description, but is only limited by the scope of the appended claims.

1. An apparatus comprising:
a plurality of pixels;
a first reaction site associated to a pixel of the plurality of pixels;
a second reaction site associated to the pixel;
wherein the first reaction site is configured to selectively transmit light of a first polarity; and
wherein the second reaction site is configured to selectively transmit light of a second polarity.

2. The apparatus of claim 1, wherein the first reaction site includes a first nanowell, and the second reaction site includes a second nanowell.

3. (canceled)

4. (canceled)

5. (canceled)

6. The apparatus of claim 1, wherein the first reaction site is configured to selectively block excitation light of the second polarity, and the second reaction site is configured to selectively block excitation light of the first polarity.

7. (canceled)

8. (canceled)

9. (canceled)

10. The apparatus of claim 1, wherein the first reaction site and the second reaction site are configured so that under illumination by excitation light of the first polarity, the first reaction site and the second reaction site exhibit a photonic power transmission ratio in favor of the first reaction site, and further so that under illumination by excitation light of the second polarity, the second reaction site and the first reaction site exhibit a photonic power transmission ratio in favor of the second reaction site.

11. (canceled)

12. (canceled)

13. (canceled)

14. The apparatus of claim 1, wherein the first reaction site and the second reaction site include respective first and second elongated apertures configured so that under illumination by excitation light of the first polarity, the first reaction site selectively transmits excitation light rays of the first polarity to a cluster location of the first reaction site, and the second reaction site selectively blocks excitation light rays of the first polarity, and further so that under illumination by excitation light of the second polarity, the second reaction site selectively transmits excitation light rays of the second polarity to a cluster location of the second reaction site and the first reaction site selectively blocks excitation light rays of the second polarity.

15. (canceled)

16. (canceled)

17. The apparatus of claim 1, wherein the first reaction site and the second reaction site include respective first and second elongated apertures configured so that under illumination by excitation light of the first polarity, the first reaction site selectively transmits excitation light rays of the first polarity to a cluster location at a cluster location elevation of the first reaction site, and the second reaction site selectively blocks excitation light rays of the first polarity, and further so that under illumination by excitation light of the second polarity, the second reaction site selectively transmits excitation light rays of the second polarity to a cluster location at a cluster location elevation of the second reaction site and the first reaction site selectively blocks excitation light rays of the second polarity, wherein the first reaction site includes a first nanowell and wherein the second reaction site includes a second nanowell, and wherein the apparatus includes a metal aperture defining layer extending over the first nanowell and the second nanowell, wherein the metal aperture defining layer has formed therein the first elongated aperture and the second elongated aperture, wherein the first elongated aperture is aligned with the first nanowell, and wherein the second elongated aperture is aligned with the second nanowell, wherein the cluster location elevation of the first reaction site is delimited by a first elevation and a second elevation, wherein the first elevation is defined by a bottom surface of the first nanowell, and the second elevation is defined by a bottom surface of the metal aperture defining layer.

18. (canceled)

19. (canceled)

20. The apparatus of claim 14, wherein the first reaction site and the second reaction site include a rectangular aperture defining the respective first and second elongated apertures.

21. The apparatus of claim 14, wherein the first reaction site and the second reaction site include an hourglass aperture defining the respective first and second elongated apertures.

22. An apparatus comprising:
a plurality of pixels;
a first reaction site associated to a pixel of the plurality of pixels;
a second reaction site associated to the pixel;
wherein the first reaction site and the second reaction site are configured so that under illumination by excitation light of a first polarity, the first reaction site and the second reaction site exhibit a photonic power transmission ratio in favor of the first reaction site.

23. The apparatus of claim 22, wherein the first reaction site includes a first nanowell and wherein the second reaction site includes a second nanowell.

24. (canceled)

25. The apparatus of claim 22, wherein the first reaction site and the second reaction site are configured so that under illumination by excitation light of a second polarity, the second reaction site and the first reaction site exhibit a photonic power transmission ratio in favor of the second reaction site.

26. (canceled)

27. The apparatus of claim 22, wherein the first reaction site and the second reaction site are configured so that under illumination by excitation light of a second polarity, the second reaction site and the first reaction site exhibit a photonic power transmission ratio in favor of the second reaction site, wherein the photonic power transmission ratio in favor of the first reaction site is at least about 2:1 wherein the photonic power transmission ratio in favor of the second reaction site is at least about 2:1.

28. (canceled)

29. (canceled)

30. (canceled)

31. (canceled)

32. (canceled)

33. (canceled)

34. The apparatus of claim 22, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture extending in a first orientation, the second elongated aperture extending in a second orientation.

35. (canceled)

36. (canceled)

37. (canceled)

38. The apparatus of claim 22, wherein the first reaction site is configured so that under illumination by excitation light of the first polarity, the first reaction site selectively transmits excitation light rays of the first polarity to a cluster location at a cluster location elevation of the first reaction site, wherein the first reaction site includes a nanowell and a metal aperture defining layer, wherein the cluster location elevation is delimited by a first elevation and a second elevation, the first elevation being defined by a bottom surface of the nanowell, and wherein the second elevation is defined by a bottom surface of the metal aperture defining layer.

39. The apparatus of claim 22, wherein second to Nth pixels of the plurality of pixels at second to Nth pixel positions have associated first and second reaction sites that are respectively configured according to the first reaction site and the second reaction site associated to the pixel, wherein the first and second reaction sites associated to adjacent pixels of the plurality of pixels have first and second different relative orientations, the first and second different relative orientations increasing a spacing distance between reaction sites at adjacent pixel positions relative to a spacing distance between reaction sites at adjacent pixel positions in the absence of the different relative orientations.

40. (canceled)

41. (canceled)

42. (canceled)

43. (canceled)

44. (canceled)

45. The apparatus of claim 22, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation, the second elongated aperture having a longitudinally extending center axis extending in a second orientation, wherein the second orientation is orthogonal to the first orientation.

46. (canceled)

47. The apparatus of claim 22, wherein the first reaction site and the second reaction site include respective first and second elongated apertures configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site, the first elongated aperture having a longitudinally extending center axis extending in a first orientation in parallel with an X-axis of a reference coordinate system, the second elongated aperture having a longitudinally extending center axis extending in a second orientation in parallel with an Y-axis of the reference coordinate system.

48. (canceled)

49. (canceled)

50. (canceled)

51. (canceled)

52. (canceled)

53. (canceled)

54. (canceled)

55. (canceled)

56. (canceled)

57. A method comprising:
detecting, using a pixel sensor of a plurality of pixels sensors, a read signal, the read signal being dependent on a first cluster signal emitted from a first reaction site associated to the pixel sensor under illumination by excitation light of a first polarity;
detecting, using a pixel sensor of a plurality of pixels sensors, a second read signal, the second read signal being dependent on a second cluster signal emitted from a second reaction site associated to the pixel sensor under illumination by excitation light of a second polarity;
determining an identity of a first analyte of interest in the first reaction site in dependence on the read signal detected using the pixel sensor; and
determining an identity of a second analyte of interest in the second reaction site in dependence on the second read signal detected using the pixel sensor.

58. The method of claim 57, wherein the first reaction site includes a first nanowell, and the second reaction site includes a second nanowell.

59. (canceled)

60. (canceled)

61. (canceled)

62. (canceled)

63. (canceled)

64. (canceled)

65. The method of claim 57, wherein the first reaction site and the second reaction site are configured so that under illumination by excitation light of a first polarity, the first reaction site and the second reaction site exhibit a photonic power transmission ratio in favor of the first reaction site, and further so that under illumination by excitation light of a second polarity, the second reaction site and the first reaction site exhibit a photonic power transmission ratio in favor of the second reaction site.

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)
